(19) United States
(12) Patent Application Publication
(10) Pub. No.: US 2026/0188073 A1
(43) Pub. Date: Jul. 2, 2026

(54) MACHINE LEARNING TECHNIQUES FOR PREDICTING PROBLEMATIC BETTING BEHAVIOR

(71) Applicant: FBG Enterprises Opco, LLC, New York, NY (US)

(72) Inventors: Aparna Sundaram, Franklin, TN (US); Bernard Jacob Loeffelholz, Spring Valley, OH (US); Jacob Andrew Weiss, Westcliffe, CO (US)

(73) Assignee: FBG Enterprises Opco, LLC, New York, NY (US)

(21) Appl. No.: 19/005,705

(22) Filed: Dec. 30, 2024

(51) Int. Cl. G07F 17/32; G06Q 50/34

(52) U.S. Cl. CPC G07F 17/323; G06Q 50/34

(57) ABSTRACT

The techniques described herein relate to machine learning (ML) techniques for predicting problematic betting behavior. An example method for predicting problematic betting behavior of users of an electronic betting platform (EBP) comprises receiving betting data associated with a user of the EBP, inputting the betting data into trained ML model(s) and outputting from the trained ML model(s) at least one respective betting behavior value representative of a likelihood that the user is to self-exclude from the EBP for problematic betting behavior, the trained ML model(s) comprising at least a first, second, and third trained ML model, identifying, from the at least one respective betting behavior value, at least one intervention operation to provide electronic support resources to the user in connection with the identified problematic betting behavior, and executing the at least one intervention operation by at least in part transmitting the electronic support resources to the user.

### FIELD

The techniques described herein relate generally to machine learning and, more particularly, to machine learning techniques for predicting problematic betting behavior.

### BACKGROUND

Electronic betting platforms, such as online casino or sports betting platforms, are readily accessible through mobile electronic devices. Gambling can be detrimental to some users that exhibit problematic betting behavior when interacting with such online betting platforms. Users who exhibit problematic betting behavior may voluntary exclude themselves from these electronic betting platforms to prevent further gambling activity.

### SUMMARY

In accordance with the disclosed subject matter, apparatus, systems, and methods are provided for machine learning techniques for predicting problematic betting behavior.

Some embodiments relate to a method for predicting problematic betting behavior of users of an electronic betting platform. The method comprises receiving, using a network interface of betting behavior monitoring software, betting data associated with a user of the electronic betting platform, wherein the betting data is generated by processing one or more electronic bets placed by the user via the electronic betting platform into the betting data, inputting the betting data into at least one trained machine learning model and outputting from the at least one trained machine learning model at least one respective betting behavior value, the at least one respective betting behavior value representative of a likelihood that the user is to self-exclude from the electronic betting platform for problematic betting behavior by the user, the at least one trained machine learning model comprising at least a first trained machine learning model, a second trained machine learning model, and a third trained machine learning model, identifying, from the at least one respective betting behavior value, at least one intervention operation to provide electronic support resources to the user in connection with the identified problematic betting behavior, and executing, using the network interface, the at least one intervention operation by at least in part transmitting the electronic support resources to the user via a computer-implemented network.

Some embodiments relate to an apparatus comprising at least one memory storing processor executable instructions, and at least one hardware processor configured to execute the processor executable instructions to perform the aforementioned method.

Some embodiments relate to at least one computer readable storage medium storing processor executable instructions that, when executed by at least one hardware processor, cause the at least one hardware processor to perform the aforementioned method.

Some embodiments relate to a system comprising at least one hardware processor, and at least one computer-readable storage medium storing processor executable instructions that, when executed by the at least one hardware processor, cause the at least one hardware processor to perform the aforementioned method.

The foregoing summary is not intended to be limiting. Moreover, various aspects of the present disclosure may be implemented alone or in combination with other aspects.

### BRIEF DESCRIPTION OF FIGURES

Various aspects and embodiments will be described with reference to the following figures. It should be appreciated that the figures are not necessarily drawn to scale. Items appearing in multiple figures are indicated by the same or a similar reference number in all the figures in which they appear.

FIG. 1 illustrates an example betting behavior monitoring system including betting behavior monitoring software to predict problematic betting behavior of users of an electronic betting platform, in accordance with some embodiments of the technology described herein.

FIG. 2 illustrates an example betting behavior classification service of the betting behavior monitoring system of FIG. 1 training multiple machine learning models to predict problematic betting behavior of users, in accordance with some embodiments of the technology described herein.

FIG. 3 is a block diagram of an example implementation of the betting behavior monitoring software of FIG. 1 generating training data for the multiple machine learning models of FIG. 2, in accordance with some embodiments of the technology described herein.

FIG. 4 is a block diagram of the implementation shown in FIG. 3 of the betting behavior monitoring software of FIG. 1 identifying intervention operation(s) in connection with detected problematic betting behavior of users(s), in accordance with some embodiments of the technology described herein.

FIG. 5 is an example implementation of a responsible gaming dashboard that may be used to identify problematic betting behavior of users(s), in accordance with some embodiments of the technology described herein.

FIG. 6 depicts a bar chart and a plot representative of example feature importance and example performance metrics, respectively, for a first one of the multiple machine learning models of FIG. 2, in accordance with some embodiments of the technology described herein.

FIG. 7 depicts a bar chart and a plot representative of example feature importance and example performance metrics, respectively, for a second one of the multiple machine learning models of FIG. 2, in accordance with some embodiments of the technology described herein.

FIG. 8 depicts a bar chart and a plot representative of example feature importance and example performance metrics, respectively, for a third one of the multiple machine learning models of FIG. 2, in accordance with some embodiments of the technology described herein.

FIG. 9 is a flowchart representative of an example process that may be performed and/or example machine-readable instructions that may be executed by processor circuitry to implement the betting behavior monitoring software of FIGS. 1, 2, 3, and/or 4 to execute an intervention operation associated with problematic betting behavior of a user, in accordance with some embodiments of the technology described herein.

FIG. 10 is a flowchart representative of an example process that may be performed and/or example machine-readable instructions that may be executed by processor circuitry to implement the betting behavior monitoring software of FIGS. 1, 2, 3, and/or 4 to identify an intervention operation associated with problematic betting behavior of a user, in accordance with some embodiments of the technology described herein.

FIG. 11 is a flowchart representative of an example process that may be performed and/or example machine-readable instructions that may be executed by processor circuitry to implement the betting behavior monitoring software of FIGS. 1, 2, 3, and/or 4 and/or the betting behavior classification service of FIGS. 1 and/or 2 to train machine learning model(s) for predicting problematic betting behavior of user(s), in accordance with some embodiments of the technology described herein.

FIG. 12 is an example electronic platform structured to execute the machine-readable instructions of FIGS. 9, 10, and/or 11 to implement the betting behavior monitoring software of FIGS. 1, 2, 3, and/or 4, in accordance with some embodiments of the technology described herein.

### DETAILED DESCRIPTION

Regulations mandate that electronic betting platforms, such as online casinos and sportsbooks, provide users with information about Responsible Gaming (RG) and self-service tools to manage their play. Although these regulations establish a minimum threshold to be met by platform operators, the present application describes techniques that raise the bar and provide enhanced RG tools and solutions for electronic betting platform users. The described techniques empower users to take control of their gaming experience and achieve a safe and enjoyable gaming environment for everyone. Beneficially, the described techniques identify users who may be exhibiting problematic betting behavior with increased accuracy and provide tailored RG resources to such users while enabling the remaining users to continue enjoying their gaming experience without unnecessary interruption.

The present application generally provides machine learning techniques for predicting problematic betting behavior of users interacting with an electronic betting platform. A user may place bets (e.g., wagers) on an electronic betting platform. Data associated with the bets may be ingested by multiple machine learning models trained to predict problematic betting behavior of users. Each of the multiple machine learning models may be trained to predict problematic betting behavior using betting data from respectively different time periods in which the user interacted with the electronic betting platform.

One(s) of the multiple machine learning models may generate output indicative of whether the user's bets represent problematic betting behavior or is likely to lead to problematic betting behavior, either of which may cause the user to self-exclude themselves from the electronic betting platform. When one(s) of the multiple machine learning models predict that the user is likely to self-exclude from the platform, intervention operation(s) such as electronically providing gambling intervention resources to the user may be carried out to support the user. Implementation of such machine learning techniques to identify users that need support represents a commitment by electronic betting platforms to promote responsible gaming.

Electronic betting platforms are readily accessible through mobile electronic devices. Example electronic betting platforms include online casinos and sports betting platforms. For example, a user can use their mobile electronic device to access an online casino to play casino table games (e.g., blackjack and roulette) and/or casino machines (e.g., slot machines, video poker machines). In another example, a user can use their mobile electronic device to place bets on sporting events.

Gambling can be detrimental to some users, who may exhibit problematic betting behavior when interacting with such online betting platforms. For example, a user can exhibit problematic betting behavior by continuously losing money, placing increasingly larger bets to attempt recouping earlier losses, making increasingly frequent bets after a recent history of losses, and/or making frequent monetary deposits to their electronic betting platform account.

Users who exhibit problematic betting behavior may take action to mitigate their own problematic betting behavior. For example, a user may use the electronic betting platform to set parameters around their betting, such as establishing deposit limits, wager limits, and cool-off periods.

Users who exhibit problematic betting behavior may take action to stop their problematic betting behavior. For example, a user may ban themselves from the electronic betting platform or a plurality of electronic betting platforms. In such an example, a user may ban themself from accessing one or more electronic betting platforms operating in their geographical area (e.g., their state)

A user banning themself and/or other otherwise electronically preventing their access to electronic betting platforms may be referred to as “self-exclusion” or “voluntary exclusion”. Exclusion programs (e.g., self-exclusion, voluntary exclusion) are run through each state's gaming enforcement department. When a user signs up to one of these state-run programs, the state puts them on a list that will prevent them from signing up or logging in at any electronic betting platform (e.g., online sportsbook or casino) within the state's jurisdiction. When the user who self-excluded attempts to log in to an electronic betting platform or sign up at a new one, the electronic betting platform operator will cross-reference the user's information to users on the self-exclusion list and prevent their access if the user is found on the list. Alternatively, some states may require the user to request bans from each casino or operator individually.

The inventors have recognized several technological challenges with identifying problematic betting behavior. First, the inventors have recognized that identifying problematic betting behavior for a plurality of users is a substantial technological undertaking. For example, an electronic betting platform may have hundreds of thousands or millions of users that use the platform on a daily basis. Such a substantial number of users may be placing multiple bets a day, which may result in millions of bets for the electronic betting platform to analyze for problematic betting behavior. Further, analyzing such a substantial number of bets is unable to be practically performed by humans, such as members of an electronic betting platform's responsible gaming team.

Second, the inventors have recognized that in many cases, users themselves must determine they have problematic betting behavior and thereby must sign up themselves to be self-excluded from electronic betting platforms. Some such users may be unable to accurately identify that they have problematic betting behavior on their own because they are unable to effectively analyze their own betting history. Further, such a manual process to self-exclude may be technologically cumbersome to a user to perform or find the necessary resources to do so.

Third, the inventors have recognized that some users who self-exclude from electronic betting platforms do so after they realize they have problematic betting behavior. Such problematic betting behavior may have resulted in undesirable monetary losses to the users that could have been prevented if the users were aware that their betting behavior was trending towards being problematic and if intervention happened proactively instead of reactively.

The inventors have developed technology that overcomes these technological challenges. The technology developed by the inventors includes betting behavior monitoring software configured to monitor betting behavior of users of an electronic betting platform for problematic betting behavior. The betting behavior monitoring software may be configured to monitor the betting behavior of users by using machine learning. For example, multiple machine learning models may be trained to classify and/or predict problematic betting behavior of users of an electronic betting platform. The multiple machine learning models may ingest betting data of users and output indications to the betting behavior monitoring software of whether one(s) of the users is/are exhibiting problematic betting behavior.

In some embodiments, each of the multiple machine learning models may be trained differently from each other using different training data and thereby may be trained to perform different inference tasks. For example, a first machine learning model may be trained using first training data from users who self-excluded from an electronic betting platform. The first training data may be betting data from a first time period in which these users interacted with an electronic betting platform. For example, the first time period may be an initial time period of the first 30 days that the users interacted (e.g., placed bets) with the electronic betting platform. The first machine learning model may be trained to classify, using a user's first 30 days of betting behavior, a betting behavior of the user in the user's first 30 days. Accordingly, the first machine learning model may be trained to predict, using the user's first 30 days of betting behavior, a likelihood that the user will self-exclude from the electronic betting platform in the future.

A second one of the multiple machine learning models may be trained using second training data from users who self-excluded from an electronic betting platform. The second training data may be betting data from a second time period in which these users interacted with the electronic betting platform. For example, the second time period may be a recent time period of the previous (e.g., most recent) 30 days that the users interacted (e.g., placed bets) with the electronic betting platform. The second machine learning model may be trained to classify, using a user's most recent 30 days of betting behavior, a betting behavior of the user in the user's most recent 30 days. Accordingly, the second machine learning model may be trained to predict, using the user's most recent 30 days of betting behavior, a likelihood that the user will self-exclude from the electronic betting platform in the future.

A third one of the multiple machine learning models may be trained using third training data from users who self-excluded from an electronic betting platform. The third training data may be betting data from a third time period in which these users interacted with the electronic betting platform. For example, the third time period may be the users' entire betting history with the electronic betting platform. In such an example, the third time period may span from the initial time period (e.g., the user's first 30 days) through the recent time period (e.g., the user's most recent 30 days). The third machine learning model may be trained to classify, using a user's cumulative or continuous betting behavior, a betting behavior of the user. Accordingly, the third machine learning model may be trained to predict, using the user's cumulative or continuous betting behavior, a likelihood that the user will self-exclude from the electronic betting platform in the future.

Advantageously, training multiple machine learning models using different training data to perform different inference tasks improves the accuracy in which an electronic betting platform may correctly identify current and future betting behavior of users. For example, the betting behavior monitoring software may use the output from the multiple machine learning models to improve the accuracy to which (i) first users who are unlikely to self-exclude and (ii) second users who are likely to self-exclude may be respectively identified.

By way of example, a particular user may have a personal history of placing substantially large and frequent bets on American football. The user may sign up for an electronic betting platform in June of a calendar year, but American football games do not typically start until September. In such an example, a machine learning model trained to only analyze the first 30 days of a particular user's betting history may inaccurately identify this particular user as unlikely to self-exclude because this particular user may be relatively inactive during the first 30 days in which American football is not occurring. Accordingly, a machine learning model trained to only analyze the first 30 days of a user's betting history may inaccurately identify this particular user as unlikely to self-exclude because the particular user may be relatively inactive during the first 30 days.

Advantageously, with respect to the above example, training multiple machine learning models to perform different inference tasks associated with different user time periods may improve detection accuracy of user problematic betting behavior. For example, the first machine learning model referenced above, which may be trained to only analyze the first 30 days, may not identify the user as likely to self-exclude, but the second machine learning model referenced above, which may be trained to analyze the most recent 30 days, may identify the user as likely to self-exclude when their betting activity substantially increases after American football begins.

In some embodiments, the betting behavior monitoring software may utilize the output from one(s) of the multiple machine learning models to identify one or more intervention operations to support electronic betting platform users to gamble responsibly. For example, the output may be representative of a degree to which a user is exhibiting problematic betting behavior.

In some embodiments, there may be multiple degrees of problematic betting behavior and each degree corresponding to different intervention operations and/or combinations of different intervention operations. By way of example, the output may be indicative that the user needs the lowest level of intervention, which may include sending electronic mail (e.g., an e-mail) to the user that includes electronic links (e.g., uniform resource locators (URLs)) to responsible gaming websites. In another example, the output may be indicative that the user needs the next highest level of intervention, which may include the electronic betting platform restricting at least one of a deposit limit, a deposit frequency, a betting limit, or a betting frequency. In yet another example, the output may be indicative that the user needs the highest level of intervention, which may include restricting the user's access to the electronic betting platform. For example, the betting behavior monitoring software may proactively complete a request to a state agency to place the user on a self-exclusion list, and provide the request to the user for execution.

Beneficially, the technology developed by the inventors solves the technological challenges associated with identifying problematic betting behavior. First, the betting behavior monitoring software solves the technological challenge of monitoring the betting behavior of hundreds of thousands or millions of users for problematic betting behavior. By using multiple machine learning models to ingest and analyze betting data for different time periods, the betting behavior monitoring software may identify one(s) of the hundreds of thousands or millions of users that may be exhibiting problematic betting behavior and identify corresponding intervention operations to support responsible gaming.

Second, the betting behavior software solves the technological challenge of users determining themselves if they have problematic betting behavior by utilizing multiple machine learning models trained to perform different inference tasks associated with different time periods of the user's betting history. By using the multiple machine learning models, the betting behavior monitoring software may determine that the current betting behavior of a user is trending towards becoming problematic betting behavior and the betting behavior monitoring software may intervene proactively. Further, the betting behavior monitoring software may automate the previously manual process of a user self-excluding from electronic betting platforms to overcome this technological challenge.

Third, the betting behavior monitoring software overcomes the technological challenge of determining when to intervene and support a user to pursue responsible gaming or no gaming at all. For example, the betting behavior monitoring software may utilize the multiple machine learning models to analyze different time periods of the user's betting behavior to proactively determine when to intervene and to what degree of intervention may be needed.

The techniques described herein may be implemented in any of numerous ways, as the techniques are not limited to any particular manner of implementation. Examples of details of implementation are provided herein solely for illustrative purposes. Furthermore, the techniques disclosed herein may be used individually or in any suitable combination, as aspects of the technology described herein are not limited to the use of any particular technique or combination of techniques.

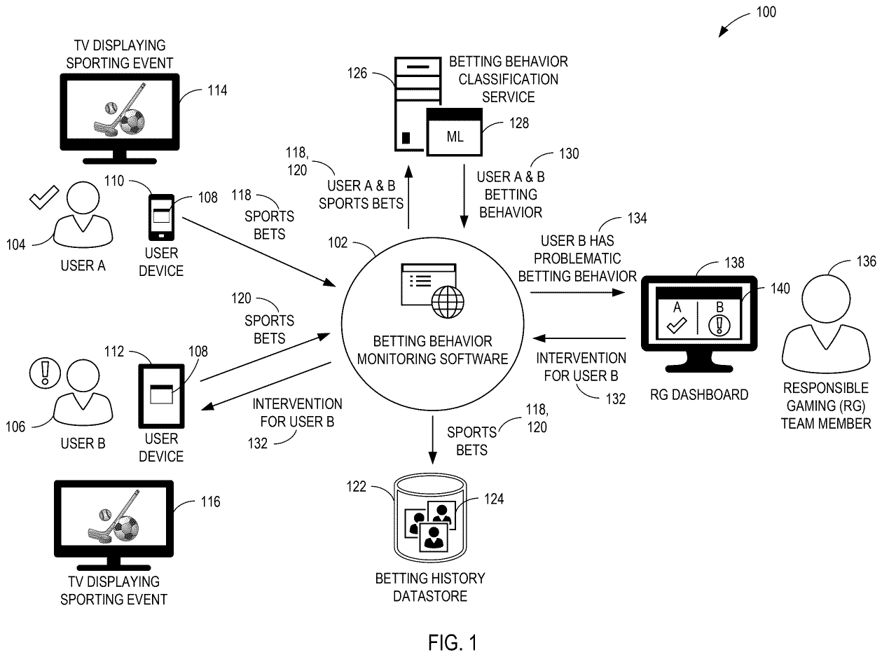

Turning to the figures, the illustrated example of FIG. 1 depicts an example betting behavior monitoring system 100, which includes betting behavior monitoring software 102 configured to predict problematic betting behavior of users 104, 106 of an electronic betting platform 108. The users 104, 106 are human users of the electronic betting platform 108. Although only two users are shown, the betting behavior monitoring software 102 and/or, more generally, the betting behavior monitoring system 100, may be configured for a plurality of users, which may be 10,000 users, 100,000 users, 1,000,000 users, 10,000,000 users, etc.

The electronic betting platform 108 shown is an electronic sports betting platform on which the users 104, 106 may place bets (e.g., wagers) on sporting events. Additionally and/or alternatively, the electronic betting platform 108 may be an online casino platform on which the users 104, 106 may wager on electronically rendered casino games (e.g., blackjack, craps, roulette, etc.) and/or casino machines (e.g., slot machines, video poker, etc.).

The electronic betting platform 108 shown is software executed on user devices 110, 112. The electronic betting platform 108 may be provided by an electronic betting platform operator, who develops, hosts, and/or manages the betting behavior monitoring software 102 and/or the electronic betting platform 108. For example, the electronic betting platform operator may develop an application (e.g., a mobile application, a mobile device application) that the users 104, 106 and upload the application to an application store for subsequent download by users, such as the users 104, 106. In such an example, the users 104, 106 may download the electronic betting platform 108 from the application store and install the electronic betting platform 108 locally on their respective user device 110, 112.

As shown, a first user 104 of the users 104, 106 interacts with the electronic betting platform 108 on a first user device 110 of the user devices 110, 112. The first user device 110 is an Internet-enabled cellular phone (e.g., a smartphone). Alternatively, the first user device 110 may be any other type of electronic device, such as a tablet computer.

As shown, a second user 106 of the users 104, 106 interacts with the electronic betting platform 108 on a second user device 112 of the user devices 110, 112. The second user device 112 is an Internet-enabled tablet computer (e.g., a tablet). Alternatively, the second user device 112 may be any other type of electronic device, such as a smartphone.

For illustrative purposes, the users 104, 106 are watching a sporting event on their respective media device 114, 116. The media devices 114, 116 in this example is a television, which may be an Internet-enabled television (e.g., a smart television). Additionally and/or alternatively, the users 104, 106 may watch sporting events on different media devices, such as Internet-enabled cellular phones (e.g., smartphones), desktop computers, laptop computers, and/or tablet computers. The users 104, 106 may be watching the same sporting event or may be watching different sporting events.

In some embodiments, the users 104, 106 may watch a sporting event on the same media device that executes the electronic betting platform 108. For example, the first user 104 may watch a sporting event on the first user device 110 and make a bet (e.g., on the sporting event or a different sporting event) through the electronic betting platform 108 on the first user device 110.

In the illustrated example, the users 104, 106 are placing sports bets 118, 120 on sporting events through the electronic betting platform 108. For example, the first user 104 is placing one or more first sports bets 118 and the second user 106 is placing one or more second sports bets 120.

The electronic betting platform 108 on the user devices 110, 112 provide and/or output the sports bets 118, 120 to the betting behavior monitoring software 102, such as via one or more computer-implemented networks (not shown). The network(s) may be implemented by any wired and/or wireless network(s) such as one or more cellular networks (e.g., 4G LTE cellular networks, 5G cellular networks, future generation 6G cellular networks, etc.), one or more data buses, one or more local area networks (LANs), one or more optical fiber networks, one or more private networks, one or more public networks, one or more satellite networks, one or more wireless local area networks (WLANs), etc., and/or any combination(s) thereof. For example, one or more of the computer-implemented networks may be the Internet, but any other type of private and/or public network is contemplated.

In some embodiments, the betting behavior monitoring software 102 is implemented by one or more servers (e.g., computer servers) accessible via a network (e.g., a computer-implemented network). For example, the betting behavior monitoring software 102 can be implemented by one or more physical servers and/or virtualizations of the one or more physical servers. In some embodiments, the one or more servers are hosted by a cloud provider (e.g., a public cloud provider, a private cloud provider) and/or an enterprise network.

As shown, the betting behavior monitoring software 102 receives the sports bets 118, 120 and outputs at least some of the sports bets 118, 120 to a betting history datastore 122. In some embodiments, the betting history datastore 122 may be configured to store betting data representative of the sports bets 118, 120. For example, the betting data for a sports bet may include at least one of a timestamp (e.g., date and/or time) corresponding to the date and/or time at which the bet was made, identifiers for the team(s) associated with the sports bet, players for the team(s) associated with the sports bet (e.g., if the sports bet is a player prop bet), an amount of the bet, a date and/or time of the sporting event pertaining to the sports bet, a type of bet (e.g., a money line bet, a spread bet, an over/under bet, a parlay, etc.), or odds of the bet or portion(s) thereof (e.g., odds for one or more legs of the bet).

In some embodiments, the betting history datastore 122 may be configured to store user profiles 124. For example, each of the users 104, 106 may have a respective one of the user profiles 124 stored in the betting history datastore 122. In such an example, the betting monitoring behavior software 102 may generate and store a first user profile of the user profiles 124 in the betting history datastore 122 when the first user 104 signs up to the electronic betting platform 108 and/or when the first user 104 places their first wager.

The user profiles 124 may include and/or store user data. Examples of user data include first and last name, demographic information, home and/or mailing address, payment information, and betting data.

Examples of betting data include historical betting data and current betting data. Historical betting data may be betting data for bets that have been completed (e.g., bets for sporting events that ended or took place). Current betting data may be betting data for bets that have not yet completed or are partially completed.

In the illustrated example, the betting behavior monitoring software 102 provides the first sports bets 118 for the first user 104 and/or the second sports bets 120 for the second user 106 to a betting behavior classification service 126. In some embodiments, the betting behavior monitoring software 102 outputs the sports bets 118, 120 received from the users 104, 106 to the betting behavior classification service 126. In some embodiments, the betting behavior monitoring software 102 processes the sports bets 118, 120 into betting data and outputs the betting data to the betting behavior classification service 126.

In some embodiments, the betting behavior classification service 126 is implemented by one or more servers (e.g., computer servers) accessible via a network (e.g., a computer-implemented network). For example, the betting behavior classification service 126 can be implemented by one or more physical servers and/or virtualizations of the one or more physical servers. In some embodiments, the one or more servers are hosted by a cloud provider (e.g., a public cloud provider, a private cloud provider) and/or an enterprise network.

As shown, the betting behavior classification service 126 can be configured to input the input the sports bets 118, 120 (and/or betting data) into at least one trained machine learning model 128 and output from the at least one trained machine learning model 128 at least one respective betting behavior value. In some embodiments, the at least one respective betting behavior value is representative of a likelihood that the first user 104 and/or the second user 106 is to self-exclude from the electronic betting platform 108 for problematic betting behavior by the first user 104 and/or the second user 106.

The at least one trained machine learning model 128 may be at least one deep learning model. Examples of a deep learning model include a neural network. Examples of a neural network include an autoencoder, a convolutional neural network (CNN), a CTC-fitted neural network model, a graph neural network (GNN), a multi-layer perceptron, a recurrent neural network (RNN), a generative adversarial network (GAN), and a transformer. For example, at least one of the at least one trained machine learning model 128 may be and/or implemented by a neural network. Additionally and/or alternatively, at least one of the at least one trained machine learning model 128 may be and/or be implemented by a different type of machine learning model, such as a clustering model, a decision tree, a support vector machine (SVM), a Bayesian network, a hidden Markov model, and/or any combination(s) thereof.

In some embodiments, the at least one trained machine learning model 128 may be configured using a deep learning model and one or more machine learning algorithms integrated into the deep learning model to perform inference tasks. For example, at least one of the at least one trained machine learning model 128 may be a neural network integrated with XGBoost to create a machine learning architecture called NNBoost. NNBoost may refer to a neural network boosting regression model that uses a gradient descent algorithm.

In some embodiments, the at least one trained machine learning model 128 includes a single machine learning model. For example, the single machine learning model may be trained to process a user's sports bets into a likelihood that the user will self-exclude from the electronic betting platform 108 due to problematic betting behavior.

In some embodiments, the at least one trained machine learning model 128 includes multiple machine learning models, such as two or more, three or more, etc., machine learning models. For example, the at least one trained machine learning model 128 may include at least one of (i) a first trained machine learning model trained to process a user's sports bets from a first time period into a likelihood that the user will self-exclude from the electronic betting platform 108 due to problematic betting behavior, (ii) a second trained machine learning model trained to process a user's sports bets from a second time period into a likelihood that the user will self-exclude from the electronic betting platform 108 due to problematic betting behavior, or (iii) a third trained machine learning model trained to process a user's sports bets from a third time period into a likelihood that the user will self-exclude from the electronic betting platform 108 due to problematic betting behavior.

In some embodiments, each of the trained machine learning models may output a respective betting behavior value representative of the likelihood of self-exclusion. For example, the betting behavior value may be a value in a range of 0 to 1, where 0 represents a very low likelihood that the user will self-exclude and 1 represents a very high likelihood that the user will self-exclude. The above range and representative values are examples and different ranges and/or values may be used.

The betting behavior value(s) are represented in FIG. 1 as user betting behavior 130 for the first user 104 and the second user 106. For example, the at least one trained machine learning model 128 may output a first betting behavior value of 0.23 for the first user 104, which may indicate that the first user 104 is unlikely to self-exclude from the electronic betting platform 108 due to problematic betting behavior. In such an example, the first user 104 may be a non-problematic betting behavior user, as represented in FIG. 1 by a checkmark icon.

In another example, the at least one trained machine learning model 128 may output a second betting behavior value of 0.78 for the second user 106, which may indicate that the second user 106 is likely to self-exclude from the electronic betting platform 108 due to problematic betting behavior. In such an example, the second user 106 may be a problematic betting behavior user, as represented in FIG. 1 by an encircled exclamation point icon.

In some embodiments, the betting behavior monitoring software 102 identifies, from the user betting behavior 130, at least one intervention operation 132 to provide electronic support resources to the user in connection with the identified problematic betting behavior. By way of example, the betting behavior monitoring software 102 may receive the user betting behavior 130 from the betting behavior classification service 126. The betting behavior monitoring software 102 may determine that the second user 106 has problematic betting behavior indicated by the second betting behavior value of 0.78.

In the illustrated example, the betting behavior monitoring software 102 may output a problematic betting behavior indication 134 associated with the second user 106 to a responsible gaming (RG) team member 136. As shown, an electronic device 138 used by the RG team member 136 may receive the indication 134 and present the indication 134 to the RG team member 136.

The electronic device 138 is a desktop computer. Alternatively, the electronic device 138 may be any other electronic device, such as a laptop, a tablet, or a smartphone.

The electronic device 138 as shown is presenting an RG dashboard 140 to the RG team member 136. The RG dashboard 140 can be configured to display and/or present betting behavior analysis of a plurality of users, such as the users 104, 106 of FIG. 1, to the RG team member 136 for evaluation. As shown, the RG dashboard 140 presents indications that the first user 104 is not a problematic betting behavior user of the electronic betting platform 108 and the second user 106 is a problematic betting behavior user of the electronic betting platform 108.

In some embodiments, the RG team member 136 may determine a degree of problematic betting behavior exhibited by a user and determine one or more intervention operations corresponding to the determined degree. In some such embodiments, the betting behavior monitoring software 102 may execute the intervention 132 specified by the RG team member 136.

In some embodiments, the betting behavior monitoring software 102 may determine the degree of problematic betting behavior exhibited by a user and determine the one or more intervention operations corresponding to the determined degree. In some such embodiments, the betting behavior monitoring software 102 may execute (e.g., automatically execute) the intervention 132 determined by betting behavior monitoring software 102.

As discussed above, there may be multiple degrees of problematic betting behavior and each degree corresponding to different intervention operations and/or combinations of different intervention operations. By way of example, the RG team member 136 and/or the betting behavior monitoring software 102 may determine, based on the betting behavior value for the second user 106, that the second user 106 needs the lowest level of intervention. The intervention 132 may implement the lowest level of intervention, which may include sending electronic mail (e.g., an e-mail) to the second user 106 that includes electronic links (e.g., uniform resource locators (URLs)) to responsible gaming websites.

In another example, the RG team member 136 and/or the betting behavior monitoring software may determine, based on the betting behavior value for the second user 106, that the second user 106 needs the next highest level of intervention. The intervention 132 may implement the next highest level of intervention, which may include the electronic betting platform 108 restricting at least one of a deposit limit, a deposit frequency, a betting limit, or a betting frequency for the second user 106.

In yet another example, the RG team member 136 and/or the betting behavior monitoring software may determine, based on the betting behavior value for the second user 106, that the second user 106 needs the highest level of intervention. The intervention 132 may implement the highest level of intervention, which may include restricting the access by the second user 106 to the electronic betting platform 108. For example, the betting behavior monitoring software 102 may proactively populate a request to a state agency to place the second user 106 on a self-exclusion list, and provide the populated request to the second user 106 for execution. Additionally and/or alternatively, the betting behavior monitoring software 102 may lock out the second user 106 from the electronic betting platform 108, such as by disabling their ability to login to the electronic betting platform 108. Alternatively, the betting behavior monitoring software 102 may restrict the access by the second user 106 to the electronic betting platform 108 such that the second user 106 may not place any bets on the electronic betting platform 108.

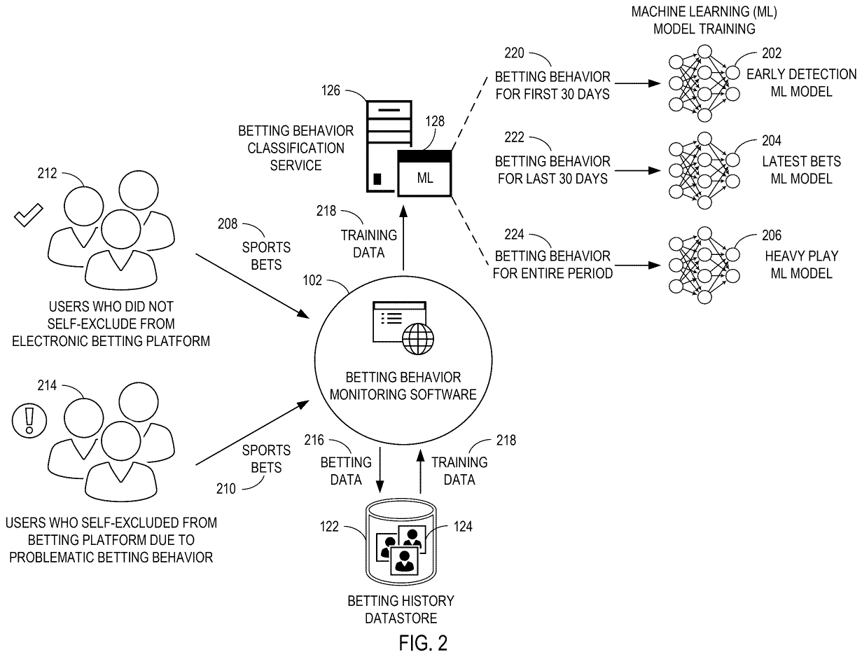

FIG. 2 illustrates the betting behavior classification service 126 of the betting behavior monitoring system 100 of FIG. 1 training multiple machine learning models 202, 204, 206 to predict problematic betting behavior of users, such as the first user 104 and the second user 106 of FIG. 1. The multiple machine learning models 202, 204, 206 may be respectively trained using different training data to perform different inference tasks to improve accuracy detection of problematic betting behavior of electronic betting platform users.

As shown, the betting behavior monitoring software 102 collects, receives, and/or obtains sports bets 208, 210 from a plurality of users 212, 214. The sports bets 208, 210 include first sports bets 208 from first users 212 and second bets 210 from second users 214. The first users 212 are users who did not self-exclude from an electronic betting platform. For example, the first users 212 may be users who did not self-exclude from the electronic betting platform 108 of FIG. 1.

The first users 214 are users who self-excluded from an electronic betting platform. For example, the second users 214 may be users who self-exclude from the electronic betting platform 108 of FIG. 1.

In the illustrated example, the betting behavior monitoring software 102 may process the sports bets 208, 210 into betting data 216. The betting behavior monitoring software 102 may process the sports bets 208, 210 into the betting data 216 by extracting portion(s) of the sports bets 208, 210 into categories, classifications, and/or groupings to improve data processing and/or analysis of such sports bets 208, 210.

The betting behavior monitoring software 102 may store the betting data 216 in the betting history datastore 122. The betting behavior monitoring software 102 may store the betting data 216 as part of a particular user's user profile 124 in the betting history datastore 122.

The betting behavior monitoring software 102 may obtain training data 218 for training the multiple machine learning models 202, 204, 206. The training data 218 may include betting data 220, 222, 224 for one or more of the machine learning models 202, 204, 206. For example, the training data 218 may include first betting data 220 that includes and/or represents betting behavior for an initial time period that a user interacts with an electronic betting platform, such as the electronic betting platform 108 of FIG. 1. In such an example, the first betting data 220 may be for one(s) of the first users 212, one(s) of the second users 214, and/or any combination(s) thereof. For example, the first betting data 220 may be betting data that is labeled as either belonging to user(s) who did not self-exclude (e.g., one(s) of the first users 212) or user(s) who self-excluded (e.g., one(s) of the second users 214).

The initial time period shown in FIG. 2 is 30 days. Alternatively, a different number of days for an initial (e.g., beginning) time period may be used, such as 10 days, 15 days, 20 days, 25 days, 35 days, 40 days, etc. A different quantifier for an initial time period may be used. For example, instead of days, an initial amount of weeks or months of the first betting data 220 may be used.

The training data 218 may include second betting data 222 that includes and/or represents betting behavior for a recent time period that a user interacts with an electronic betting platform, such as the electronic betting platform 108 of FIG. 1. In such an example, the second betting data 222 may be for one(s) of the first users 212, one(s) of the second users 214, and/or any combination(s) thereof. For example, the second betting data 222 may be betting data that is labeled as either belonging to user(s) who did not self-exclude (e.g., one(s) of the first users 212) or user(s) who self-excluded (e.g., one(s) of the second users 214).

The recent time period shown in FIG. 2 is 30 days. Alternatively, a different number of days for a recent time period may be used, such as the last (e.g., previous) 10 days, 15 days, 20 days, 25 days, 35 days, 40 days, etc. A different quantifier for a recent time period may be used. For example, instead of days, an initial amount of weeks or months of the first betting data 220 may be used.

The training data 218 may include third betting data 224 that includes and/or represents betting behavior for an entire time period that a user interacts with an electronic betting platform, such as the electronic betting platform 108 of FIG. 1. In such an example, the third betting data 224 may be for one(s) of the first users 212, one(s) of the second users 214, and/or any combination(s) thereof. For example, the third betting data 224 may be betting data that is labeled as either belonging to user(s) who did not self-exclude (e.g., one(s) of the first users 212) or user(s) who self-excluded (e.g., one(s) of the second users 214).

In the illustrated example, the betting behavior classification service 126 trains at least one of the multiple machine learning models 202, 204, 206 using the training data 218. The multiple machine learning models 202, 204, 206 shown in FIG. 2 include a first machine learning model 202, a second machine learning model 204, and a third machine learning model 206.

As shown, the first machine learning model 202 is an early detection machine learning model configured to predict, using a user's betting behavior on an electronic betting platform for an initial time period, a likelihood that the user will self-exclude from the electronic betting platform. For example, the betting behavior classification service 126 may train, using the first betting data 220, the first machine learning model 202 to predict and/or output a likelihood that a user is to self-exclude based on their initial betting/gambling interactions with an electronic betting platform.

As shown, the second machine learning model 204 is a latest bets machine learning model configured to predict, using a user's betting behavior on an electronic betting platform for a recent time period, a likelihood that the user will self-exclude from the electronic betting platform. For example, the betting behavior classification service 126 may train, using the second betting data 222, the second machine learning model 204 to predict and/or output a likelihood that a user is to self-exclude based on their recent betting/gambling interactions with an electronic betting platform.

As shown, the third machine learning model 206 is a heavy play machine learning model configured to predict, using a user's entire and/or cumulative betting behavior on an electronic betting platform, a likelihood that the user will self-exclude from the electronic betting platform. For example, the betting behavior classification service 126 may train, using the third betting data 224, the third machine learning model 206 to predict and/or output a likelihood that a user is to self-exclude based on their entire and/or cumulative betting/gambling interactions with an electronic betting platform.

In some embodiments, the betting behavior classification service 126 may train the machine learning models 202, 204, 206 until a threshold is reached, met, and/or satisfied. For example, the betting behavior classification service 126 may train the first machine learning model 202 until an accuracy of the first machine learning model 202 reaches, meets, and/or exceeds an accuracy threshold. In such an example, the betting behavior classification service 126 may determine to continue to train (e.g., retrain) the first machine learning model 202 when an accuracy of the first machine learning model 202 is 60% and is below an accuracy threshold of 80%. In another example, the betting behavior classification service 126 may determine to stop training the first machine learning model 202 when an accuracy of the first machine learning model 202 is 90% and is above the accuracy threshold of 80% and the accuracy of 90% thereby satisfies the accuracy threshold of 80%. The above percentages are examples and other accuracy and/or accuracy threshold percentage values. Additionally and/or alternatively, an accuracy and/or accuracy threshold may be represented differently such as in decimal format.

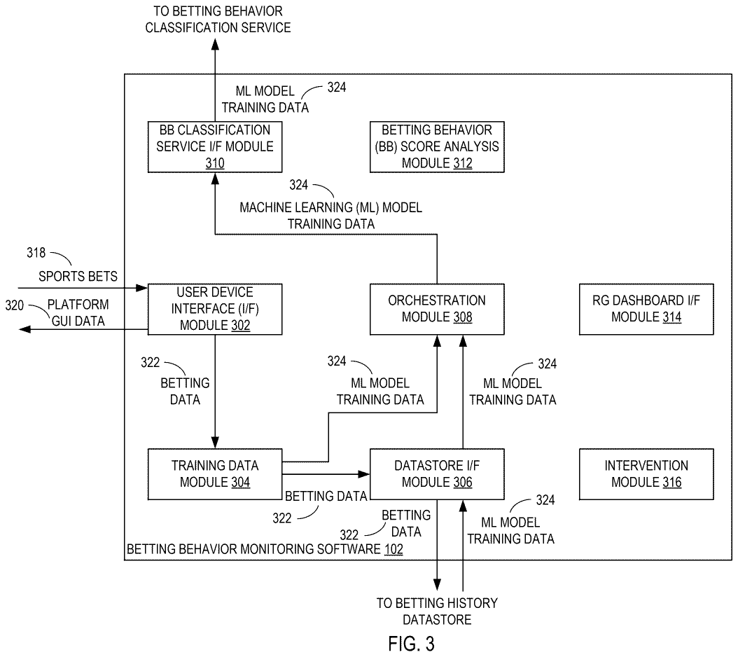

FIG. 3 is a block diagram of an example implementation of the betting behavior monitoring software 102 of FIGS. 1 and/or 2 generating training data for the multiple machine learning models 202, 204, 206 of FIG. 2. The implementation shown in FIG. 3 includes an example user device interface module 302, an example training data module 304, an example datastore interface module 306, an example orchestration module 308, and example betting behavior classification service interface module 310, an example betting behavior score analysis module 312, an example responsible gaming (RG) dashboard interface module 314, and an example intervention module 316.

In the illustrated example, the user device interface module 302 receives electronic data from and/or transmits electronic data to a user device, such as the user devices 110, 112 of FIG. As shown, the electronic data may be implemented by sports bets 318 and platform graphical user interface (GUI) data 320. In some embodiments, the sports bets 318 may be implemented by and/or correspond to the sports bets 118, 120 of FIG. 1 and/or the sports bets 208, 210 of FIG. 2.

In some embodiments, the platform GUI data 320 may be data to be presented on a GUI of a user device. For example, the platform GUI data 320 may be data to be loaded into a GUI implemented by the electronic betting platform 108 and presented to the users 104, 106 via the user devices 110, 112. Examples of platform GUI data 320 include sports bet options, promotional and/or marketing information, and gambling intervention resources. Examples of sports bet options include available bets (e.g., available bets that can be made for particular sports, teams, players, etc.), sports scheduling information (e.g., a date and/or time at which a particular sporting event will begin), odds information, and winning payout information.

The user device interface module 302 may implement and/or include one or more network interfaces configured to exchange data with a network, such as a computer-implemented network. The network may be implemented by any wired and/or wireless network(s) such as one or more cellular networks (e.g., 4G LTE cellular networks, 5G cellular networks, future generation 6G cellular networks, etc.), one or more data buses, one or more local area networks (LANs), one or more optical fiber networks, one or more private networks, one or more public networks, one or more satellite networks, one or more wireless local area networks (WLANs), etc., and/or any combination(s) thereof. For example, the network may be the Internet, but any other type of private and/or public network is contemplated.

As shown, the user device interface module 302 may receive the sports bets 318 from one or more user devices. The user device interface module 302 may output the sports bets 318 as betting data 322 to the training data module 304. For example, the user device interface module 302 may extract, parse, and/or process the sports bets 318 into identifications of what bets were made by users (e.g., which team, player, etc., was bet on), a type of bet (e.g., a money line, an over/under, a parlay), a monetary amount of the bet, and/or a timestamp at which the bet was made.

The training data module 304 may output the betting data 322 received from the user device interface module 302 to the datastore interface module 306. The datastore interface module 306 may output the betting data 322 for storage in the betting history datastore 122. In some embodiments, the datastore interface module 306 may store the betting data 322 in connection with one(s) of the user profiles 124 associated with users who placed the sports bets 318.

The training data module 304 may process the betting data 322 into machine learning model training data 324. For example, the training data module 304 may label the betting data 322 as belonging to a user that self-excluded from the electronic betting platform 108 or did not self-exclude from the electronic betting platform 108. In such an example, the training data module 304 may label the betting data 322 as belonging to one of the first users 212 or the second users 214 of FIG. 2.

The training data module 304 may output the machine learning model training data 324 to the orchestration module 308. The orchestration module 308 may direct, steer, and/or manage one(s) of the various modules of the betting behavior monitoring software 102. In this example, the orchestration module 308 provides the machine learning model training data 324 to the betting behavior classification service interface module 310 to effectuate training of one or more machine learning models.

As shown, the betting behavior classification service interface module 310 outputs the machine learning model training data 324 to the betting behavior classification service 126 of FIGS. 1 and/or 2. For example, the betting behavior classification service interface module 310 may implement and/or include one or more network interfaces configured to exchange data with the betting behavior classification service 126 via a network, such as a computer-implemented network. In some embodiments, the betting behavior classification service interface module 310 may output the machine learning model training data 324 to the betting behavior classification service 126 as the training data 218 of FIG. 2.

While an example implementation of the betting behavior monitoring software 102 is depicted in FIG. 3, other implementations are contemplated. For example, one or more blocks, components, functions, etc., of the betting behavior monitoring software 102 may be combined or divided in any other way. The betting behavior monitoring software 102 of the illustrated example may be implemented by hardware alone, or by a combination of hardware, software, and/or firmware. For example, the betting behavior monitoring software 102 may be implemented by one or more analog or digital circuits (e.g., comparators, operational amplifiers, etc.), one or more hardware-implemented state machines, one or more programmable processors (e.g., central processing units (CPUs), digital signal processors (DSPs), field programmable gate arrays (FPGAs), graphics processing units (GPUs), etc.), one or more network interfaces (e.g., network interface circuitry, network interface cards (NICs), smart NICs, etc.), one or more application specific integrated circuits (ASICs), one or more memories (e.g., non-volatile memory, volatile memory, etc.), one or more mass storage disks or devices (e.g., hard-disk drives (HDDs), solid-state disk (SSD) drives, etc.), etc., and/or any combination(s) thereof.

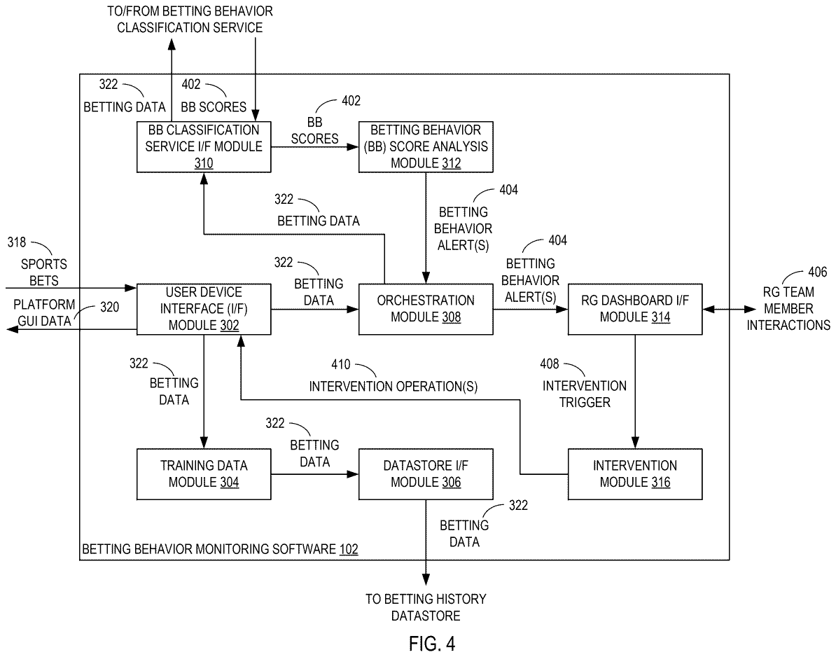

FIG. 4 is a block diagram of the implementation shown in FIG. 3 of the betting behavior monitoring software 102 of FIGS. 1 and/or 2 identifying intervention operation(s) in connection with detected problematic betting behavior of users(s). For example, the betting behavior monitoring software 102 may be executed to determine whether a user is exhibiting problematic betting behavior and/or a degree of intervention to support the user.

As shown, the user device interface module 302 receives the sports bets 318 from user(s). For example, the user device interface module 302 may receive the sports bets 318 from a plurality of users, which may include thousands, tens of thousands, hundreds of thousands, or millions of users in substantially real-time. The term “substantially real-time” may refer to occurrence in a near instantaneous manner recognizing there may be real-world delays for computing time, transmission, etc. For example, the user device interface module 302 may receive a sports bet placed by a user within 5 seconds, 1 second, 500 milliseconds, 100 milliseconds, 10 milliseconds, etc., of real time after the user placed the sports bet.

The user device interface module 302 may output the sports bet 318 as the betting data 322 to the training data module 304. The training data module 304 may output the betting data 322 to the datastore interface module 306 for subsequent storage in the betting history datastore 122.

In some embodiments, the training data module 304 may process the betting data 322 into the machine learning model training data 324 of FIG. 3 and output the machine learning model training data 324 to the datastore interface module 306 for subsequent storage in the betting history datastore 122. In some such embodiments, the orchestration module 308 may retrieve the machine learning model training data 324 from the betting history datastore 122 when the orchestration module 308 determines to retrain one(s) of the machine learning models 202, 204, 206 of FIG. 2.

The user device interface module 302 may output the betting data 322 to the orchestration module 308 which, in turn, may output the betting data 322 to the betting behavior classification service interface module 310. The betting behavior classification service interface module 310 may output the betting data 322 to the betting behavior classification service 126 of FIGS. 1 and/or 2.

In some embodiments, the betting behavior classification service 126 may input the betting data 322 into at least one of the multiple machine learning models 202, 204, 206 and output, from the at least one of the multiple machine learning models 202, 204, 206, a respective betting behavior score. For example, the betting behavior classification service 126 may input the betting data 322 associated with user(s) into the first machine learning model 202 and output from the first machine learning model 202 first betting behavior score(s) for the respective user(s). The first betting behavior score(s) may be value(s) (e.g., betting behavior value(s)) representative of likelihood(s) that, based on the user(s) initial time period betting data, will self-exclude from the electronic betting platform 108 for problematic betting behavior by the user(s).

The betting behavior classification service 126 may input the betting data 322 associated with the user(s) into the second machine learning model 204 and output from the second machine learning model 204 second betting behavior score(s) for the respective user(s). The second betting behavior score(s) may be value(s) (e.g., betting behavior value(s)) representative of likelihood(s) that, based on the user(s) most recent time period betting data, will self-exclude from the electronic betting platform 108 for problematic betting behavior by the user(s).

The betting behavior classification service 126 may input the betting data 322 associated with the user(s) into the third machine learning model 206 and output from the third machine learning model 206 third betting behavior score(s) for the respective user(s). The third betting behavior score(s) may be value(s) (e.g., betting behavior value(s)) representative of likelihood(s) that, based on the user(s) cumulative time period betting data, will self-exclude from the electronic betting platform 108 for problematic betting behavior by the user(s).

In some embodiments, the betting behavior classification service interface module 310 may receive the first, second, and/or third betting behavior scores as betting behavior scores 402. The betting behavior classification service interface module 310 may output the betting behavior scores 402 to the betting behavior score analysis module 312.

As shown, the betting behavior score analysis module 312 may process the betting behavior scores 402 into betting behavior alert(s) 404. The betting behavior score analysis module 312 may generate the betting behavior alert(s) 404 based on combined betting behavior scores. For example, the betting behavior score analysis module 312 may determine a combined betting behavior score (e.g., a combined RG score) for a user based on the first, second, and/or third betting behavior scores for the user. In such an example, the combined betting behavior score may be an average (e.g., a weighted average) of the first, second, and/or third betting behavior scores for the user.

The betting behavior score analysis module 312 may generate the betting behavior alert 404 for a user when the combined betting behavior score meets, reaches, and/or exceeds a threshold. For example, the betting behavior score analysis module 312 may receive, for the first user 104 of FIG. 1, a first betting behavior score of 0.27 from the first machine learning model 202, a second betting behavior score of 0.43 from the second machine learning model 204, and a third betting behavior score of 0.38 from the third machine learning model 206. In such an example, the betting behavior score analysis module 312 may determine a combined betting behavior score of 0.36 for the first user 104 based on an average of 0.27, 0.43, and 0.38. The betting behavior score analysis module 312 may determine that the combined betting behavior score of 0.36 is less than an alert threshold of 0.70 and thereby determine that the first user 104 does not have problematic betting behavior. The above provided scores and alert threshold are examples and different values may be used.

In another example, the betting behavior score analysis module 312 may receive, for the second user 106 of FIG. 1, a first betting behavior score of 0.62 from the first machine learning model 202, a second betting behavior score of 0.93 from the second machine learning model 204, and a third betting behavior score of 0.85 from the third machine learning model 206. In such an example, the betting behavior score analysis module 312 may determine a combined betting behavior score of 0.80 for the second user 106 based on an average of 0.62, 0.93, and 0.85. The betting behavior score analysis module 312 may determine that the combined betting behavior score of 0.80 is greater than the alert threshold of 0.70 and thereby determine that the second user 106 has problematic betting behavior. The above provided scores and alert thresholds are examples and different values may be used.

Furthering the above example, in response to determining that the combined betting behavior score of 0.80 is greater than the alert threshold of 0.70, the betting behavior score analysis module 312 may generate a betting behavior alert 404 in connection with the second user 106. The betting behavior score analysis module 312 may output the betting behavior alert 404 for the second user 106 (and/or alert(s) for other user(s)) to the orchestration module 308.

The orchestration module 308 may direct the betting behavior alert(s) 404 to the RG team member 136 of FIG. 1 via the dashboard interface module 314. Interactions between the betting behavior monitoring software 102 and the RG team member 136 of FIG. 1 are represented in FIG. 4 as RG team member interactions 406. For example, the RG team member interactions 406 may include the dashboard interface module 314 outputting the betting behavior alert(s) 404 to the electronic device 138 of FIG. 1. The electronic device 138 can present the betting behavior alert(s) 404 to the RG team member 136 via the RG dashboard 140 of FIG. 1. In such an example, the betting behavior alert 404 for the second user 106 may be represented in FIG. 1 as the encircled exclamation point in the RG dashboard 140 to convey to the RG team member 136 that the second user 106 is exhibiting problematic betting behavior and/or is trending towards exhibiting problematic betting behavior.

In the illustrated example, the RG team member interactions 406 may include the RG team member 136 by generating an intervention trigger 408 to cause one or more intervention operations 410 to be executed in connection with the second user 106. For example, the RG team member 136 may determine that the combined betting behavior score for the second user 106 corresponds to a particular degree of intervention to support the second user 106 game responsibly. Additionally and/or alternatively, the dashboard interface module 314 may output the betting behavior alert(s) 404 as the intervention trigger 408 to cause (e.g., automatically cause) the intervention operation(s) 410 to be executed.

The intervention module 316 may identify, from at least one respective betting behavior score for a user and/or a combined betting behavior score for the user, at least one intervention operation 410. The at least one intervention operation 410 may include providing electronic support resources to the second user 106 in connection with the identified problematic betting behavior of the second user 106. For example, the intervention module 316 may cause the user device interface module 302 to generate and/or send electronic mail (e.g., an e-mail) to the second user 106 that includes electronic links (e.g., uniform resource locators (URLs)) to responsible gaming websites.

In some embodiments, the at least one intervention operation 410 may include the intervention module 316 may restrict at least one of a deposit limit, a deposit frequency, a betting limit, or a betting frequency for the second user 106. For example, the user device interface module 302 may output the restriction(s) as part of the platform GUI data 320 to update the electronic betting platform 108 operating on the user device 112 of the second user 106.

The at least one intervention operation 410 may include the intervention module 316 restricting access by the second user 106 to the electronic betting platform 108 to place bets. For example, the user device interface module 302 may output the restricted access control as part of the platform GUI data 320 to update the electronic betting platform 108 operating on the user device 112 of the second user 106 to restrict access by the second user 106 to place bets.

The at least one intervention operation 410 may include populating a request to a state agency to place the second user 106 on a self-exclusion list, and provide the populated request (e.g., as part of the platform GUI data 320) to the second user 106 for execution by the second user 106. In some embodiments, any combination(s) of the above intervention operations 410 may be carried out in connection with supporting the second user 106.

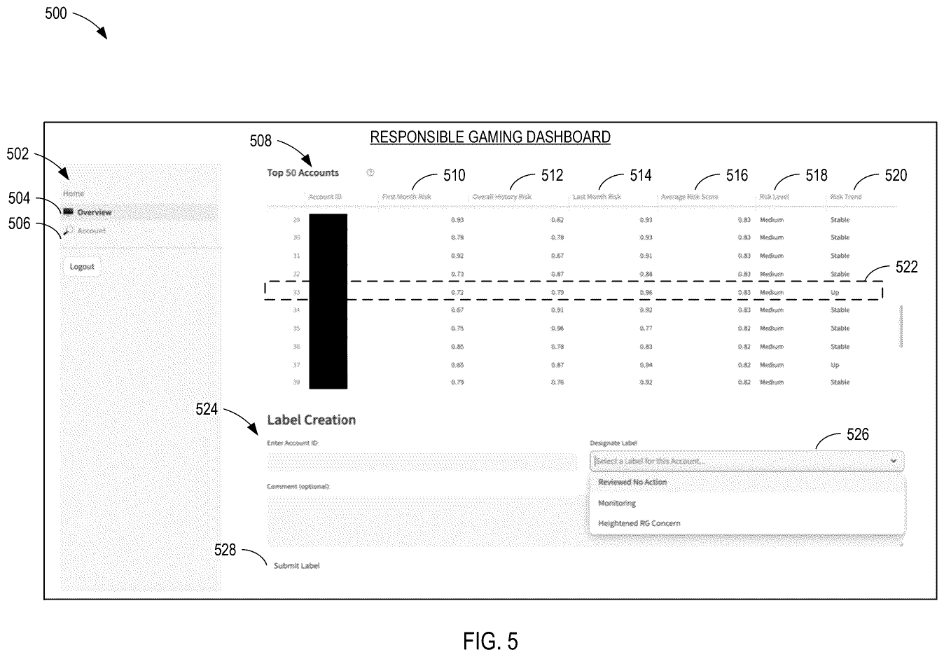

FIG. 5 is an example implementation of a responsible gaming dashboard 500 that may be used to identify problematic betting behavior of users(s). In some embodiments, the responsible gaming dashboard 500 may implement the RG dashboard 140 of FIG. 1. For example, the RG team member 136 of FIG. 1 may be presented with the responsible gaming dashboard 500 of FIG. 5 on the electronic device 138 of FIG. 1.

As shown, the responsible gaming dashboard 500 is a GUI that may be used by and/or presented to the RG team member 136 of FIG. 1 to detect and/or identify problematic betting behavior for one or more users of the electronic betting platform 108 of FIG. 1. The responsible gaming dashboard 500 includes a navigation pane 502 that enables the RG team member 136 to view betting behavior scores for a plurality of users by selecting an overview display option 504 or to view betting behavior scores for user(s) that can be looked up using a search option 506.

As shown, the responsible gaming dashboard 500 displays a main GUI portion 508. The main GUI portion 508 may be displayed in response to the RG team member 136 selecting the overview screen option 506. The main GUI portion 508 displays a plurality of users identified by “Account ID”.

The main GUI portion 508 also displays risk scores 510, 512, 514, 516 for each of the displayed users. One(s) of the risk scores 510, 512, 514, 516 may be values (e.g., risk values) output from the at least one trained machine learning model 128 of FIG. 1 and/or the machine learning models 202, 204, 206 of FIG. 2.

The risk scores 510, 512, 514, 516 may be representative of a degree to which a user is engaging in risky and/or problematic betting behavior. For example, the risk scores 510, 512, 514, 516 may correspond to the betting behavior scores 402 of FIG. 4. In such an example, the risk scores 510, 512, 514, 516 may be representative of a likelihood that the user will self-exclude from the electronic betting platform 108.

The risk scores 510, 512, 514, 516 include a first risk score 510 (identified by “First Month Risk”) representative of a degree to which a user is engaging in risky and/or problematic betting behavior as determined by the user's first month (e.g., the first 30 days, an initial time period) of betting data. For example, the first risk score 510 may be output from the first machine learning model 202 of FIG. 2.

The risk scores 510, 512, 514, 516 include a second risk score 512 (identified by “Overall History Risk”) representative of a degree to which a user is engaging in risky and/or problematic betting behavior as determined by the user's cumulative betting data. For example, the second risk score 512 may be output from the third machine learning model 206 of FIG. 2.

The risk scores 510, 512, 514, 516 include a third risk score 514 (identified by “Last Month Risk”) representative of a degree to which a user is engaging in risky and/or problematic betting behavior as determined by the last month (e.g., the last 30 days, a recent time period) of betting data. For example, the third risk score 514 may be output from the second machine learning model 204 of FIG. 2.

The risk scores 510, 512, 514, 516 include a fourth risk score 516 (identified by “Average Risk Score”) representative of a degree to which a user is engaging in risky and/or problematic betting behavior as determined by a combination (e.g., an average) of a user's first through third risk scores 510, 512, 514. Alternatively, the fourth risk score 516 may be determined using a different combination of the user's first through third risk scores 510, 512, 514, such as a weighted average thereof.

The main GUI portion 508 also shows a risk level 518 for each user. The risk level 518 may correspond to at least one of the first risk score 510, the second risk score 512, the third risk score 514, or the fourth risk score 516. In some embodiments, the risk level 518 may have several risk level categories, such as “Low”, “Medium”, and “High” to represent relatively low, medium, and high risk levels, respectively.

By way of example, a user with a relatively low fourth risk score 516, such as 0.25 in a range of 0 to 1, may have a risk level of “Low”. In another example, a user with a relatively high fourth risk score 516, such as 0.90 in a range of 0 to 1, may have a risk level of “High”. In yet another example, a user with a fourth risk score 516 between a relatively low and a relatively score, such as 0.60 or 0.80 in a range of 0 to 1, may have a risk level of “Medium”.

The main GUI portion 508 also shows a risk trend 520 for each user. The risk trend 520 may be based on at least one of the first risk score 510, the second risk score 512, the third risk score 514, or the fourth risk score 516 over time. In some embodiments, the risk trend 520 may have several risk trend categories, such as “Down”, “Stable”, and “Up” to represent a downward, stable, and upward trajectory of the risk scores and/or the risk level respectively.

In some embodiments, the risk trend 520 may be calculated and/or determined based on a time window. For example, the time window may be a number of days (e.g., 3, 5, 7, 10, 14, etc., days), weeks (e.g., 1, 2, 3, 4, etc., weeks), or months (e.g., 1, 2, 3, 4, etc., months). For example, the risk scores 510, 512, 514, 516 for a user may be output from the at least one trained machine learning model 128 daily, the time window may be a 7-day time window, and the risk trend 520 for the user may be determined using one(s) of the risk scores 510, 512, 514, 516 for the user for the previous 7 days. Alternatively, the risk scores 510, 512, 514, 516 may be calculated in a different manner, such as being recalculated (e.g., using the at least one trained machine learning model 128) every time the user places a bet, every hour, every other day, etc.

By way of example, a user 522 corresponding to row 33 of the table of users shown in the main GUI portion 508 has a first risk score 510 of 0.72 and a third risk score 514 of 0.96, which indicates that the user 522 has betting behavior that is becoming increasingly risky and/or problematic over time. In the shown example, the user 522 has an “Up” risk trend 520 to represent the increase in risky and/or problematic betting behavior over time.

In the illustrated example, the responsible gaming dashboard 500 also displays an intervention GUI portion 524. The intervention GUI portion 524 may enable the RG team member 136 to create labels for user(s) whose betting behavior they have reviewed. Using selectable options 526 in the intervention GUI portion 524, the RG team member 136 may identify a particular user by entering an account ID (identified by the “Enter Account ID:” field), adding any comments (identified by the “Comment (optional):” field), and designating a label for the user (identified by the “Designate Label” drop-down menu).

As shown, the RG team member 136 may add, by selecting one of the “Designate Label” drop-down menu options, one of the labels of “Reviewed No Action”, “Monitoring”, or “Heightened RG Concern” to the specified user. For example, the RG team member 136 may select a first user and add a label of “Reviewed No Action” to the first user's profile (e.g., one of the user profiles 124 of FIG. 1 that may be identified by the user's Account ID) to indicate that the first user does not have problematic betting behavior. After the selection, the RG team member 136 may press the “Submit Label” 528 button to save the data association of at least the label and the first user's profile.

In another example, the RG team member 136 may select a second user and add a label of “Heightened RG Concern” to the second user's profile (e.g., one of the user profiles 124 of FIG. 1 that may be identified by the user's Account ID) to generate the intervention trigger 408 of FIG. 4. In such an example, responsive to the generation of the intervention trigger 408, the intervention operation(s) 410 may be triggered for execution for the second user.

In some embodiments, the intervention trigger 408 may be generated in response to and/or based at least in part on one(s) of the risk scores 510, 512, 514, 516. For example, the betting behavior monitoring software 102 and/or the RG team member 136 may determine to take no action when at least one of the risk scores 510, 512, 514, 516 is less than 0.50.

In another example, the betting behavior monitoring software 102 and/or the RG team member 136 may determine to send an e-mail including responsible gaming resources to a user when at least one of the risk scores 510, 512, 514, 516 is greater than or equal to 0.50 and less than 0.70.

In yet another example, the betting behavior monitoring software 102 and/or the RG team member 136 may determine to push a pop-up notification through the electronic betting platform 108 on the user's device including responsible gaming resources when at least one of the risk scores 510, 512, 514, 516 is greater than or equal to 0.70 and less than 0.80.

Additionally and/or alternatively, the betting behavior monitoring software 102 and/or the RG team member 136 may determine to initiate an electronic chat through the electronic betting platform 108 between the second user 106 and the RG team member 136. In some embodiments, the electronic chat may be implemented at least in part by a large language model (LLM) generating automated responses to text input by at least one of the second user 106 or the RG team member 136. In some embodiments, the LLM may replace the RG team member 136 in the electronic chat with the second user 106.

In another example, the betting behavior monitoring software 102 and/or the RG team member 136 may determine to impose one or more limits (e.g., a deposit limit, a wager limit, etc.) on the user's betting behavior when at least one of the risk scores 510, 512, 514, 516 is greater than or equal to 0.80 and less than 0.90.

In yet another example, the betting behavior monitoring software 102 and/or the RG team member 136 may determine to impose a cooling off period and/or initiate a self-exclusion operation for the user when at least one of the risk scores 510, 512, 514, 516 is greater than or equal to 0.90. The above risk score values are examples and different risk score values and/or ranges may be used in connection with the above intervention operations and/or combination(s) thereof.

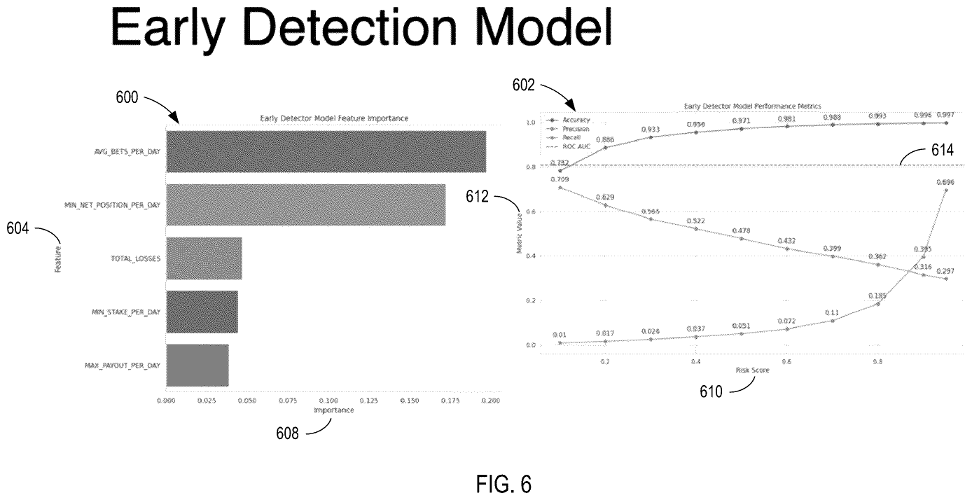

FIG. 6 depicts a bar chart 600 and a plot 602 representative of feature importance and performance metrics, respectively, for the first machine learning model 202 of FIG. 2. As shown, the bar chart 600 shows features 604 of betting data measured during an initial time period in which users interact with an electronic betting platform and their respective importance on determining the output of the first machine learning model 202.

The bar chart 600 includes a y-axis representative of each of the betting data features 604. The y-axis includes the betting data features 604 of an average number of bets per day (identified by “AVG_BETS_PER_DAY”), a minimum net position per day (e.g., the lowest amount a user has netted on a per day basis) (identified by “MIN_NET_POSITION_PER_DAY”), total losses (identified by “TOTAL_LOSSES”), a minimum betting stake per day (identified by “MIN_STAKE_PER_DAY”), and a maximum payout per day (identified by “MAX_PAYOUT_PER_DAY”).

The bar chart 600 includes an x-axis representative of a degree of importance 608 for each of the betting data features 604. The x-axis has a range of 0.000 to 0.200, but a different range may be used.

In the bar chart 600, the AVG_BETS_PER_DAY and the MIN_NET_POSITION_PER_DAY features 604 have the greatest importance for determining the output of the first machine learning model 202 of FIG. 2. For example, these features 604 of the betting data during an initial time period (e.g., a first 30 days) in which a user interacts with the electronic betting platform 108 may have the most impact on the first machine learning model 202 determining the betting behavior value for the user.

The plot 602 represents the performance metrics for the first machine learning model 202. The plot 602 includes an x-axis of risk scores 610 in a range of 0.0 to 1.0. In some embodiments, the risk scores 610 may be the betting behavior scores 402 of FIG. 4 and/or one(s) of the risk scores 510, 512, 514, 516 of FIG. 5.

The plot 602 includes a y-axis of performance metric values 612 in a range of 0.0 to 1.0. The performance metric values 612 are shown for performance metrics of accuracy, precision, and recall for the first machine learning model 202. The plot 602 also shows a Receiver Operating Characteristic Area Under the Curve (ROC AUC) metric 614 that may measure how well the first machine learning model 202 can distinguish between classes. As shown, the accuracy and precision performance metrics increase and the recall performance metric decreases as the risk score 610 increases.

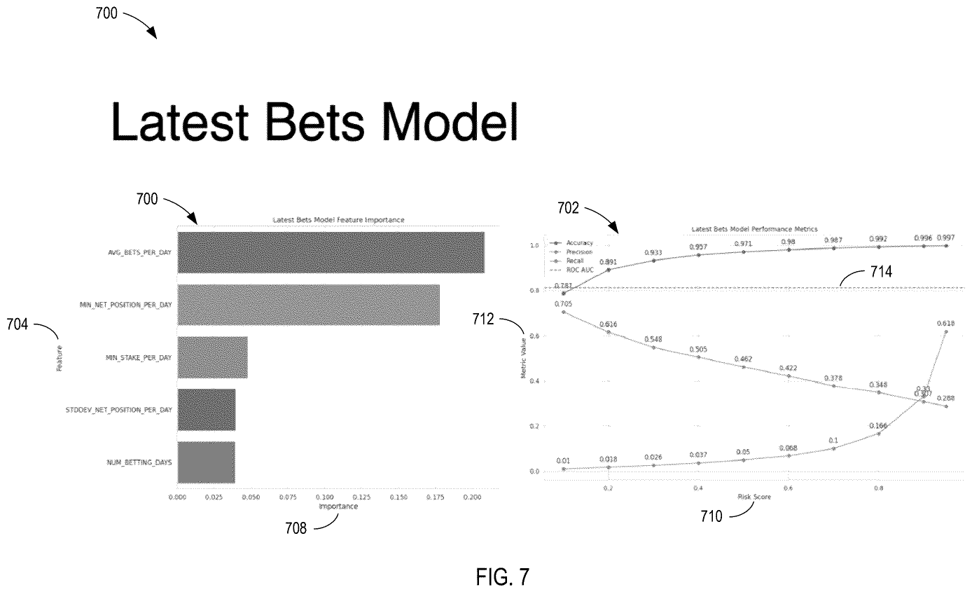

FIG. 7 depicts a bar chart 700 and a plot 702 representative of feature importance and performance metrics, respectively, for the second machine learning model 204 of FIG. 2. As shown, the bar chart 700 shows features 704 of betting data measured during a recent time period in which users interact with an electronic betting platform and their respective importance on determining the output of the second machine learning model 202.

The bar chart 700 includes a y-axis representative of each of the betting data features 704. The y-axis includes the betting data features 704 of an average number of bets per day (identified by “AVG_BETS_PER_DAY”), a minimum net position per day (e.g., the lowest amount a user has netted on a per day basis) (identified by “MIN_NET_POSITION_PER_DAY”), total losses (identified by “TOTAL_LOSSES”), a minimum betting stake per day (identified by “MIN_STAKE_PER_DAY”), and a maximum payout per day (identified by “MAX_PAYOUT_PER_DAY”).

The bar chart 700 includes an x-axis representative of a degree of importance 708 for each of the betting data features 704. The x-axis has a range of 0.000 to 0.200, but a different range may be used.

In the bar chart 700, the AVG_BETS_PER_DAY and the MIN_NET_POSITION_PER_DAY features 704 have the greatest importance for determining the output of the second machine learning model 204 of FIG. 2. For example, these features 704 of the betting data during a recent time period (e.g., the previous 30 days) in which a user interacts with the electronic betting platform 108 may have the most impact on the second machine learning model 204 determining the betting behavior value for the user.

Further, the bar chart 700 shows that these features 704 have more importance for the second machine learning model 204 than these same ones of the features 604 of FIG. 6 have for the first machine learning model 202. For example, the AVG_BETS_PER_DAY feature during a recent time period has more importance for predicting a likelihood of a user self-excluding from the electronic betting platform 108 than the AVG_BETS_PER_DAY feature during an initial time period.

The plot 702 represents the performance metrics for the second machine learning model 204. The plot 702 includes an x-axis of risk scores 710 in a range of 0.0 to 1.0. In some embodiments, the risk scores 710 may be the betting behavior scores 402 of FIG. 4 and/or one(s) of the risk scores 510, 512, 514, 516 of FIG. 5.

The plot 702 includes a y-axis of performance metric values 712 in a range of 0.0 to 1.0. The performance metric values 712 are shown for performance metrics of accuracy, precision, and recall for the second machine learning model 204. The plot 702 also shows a Receiver Operating Characteristic Area Under the Curve (ROC AUC) metric 714 that may measure how well the second machine learning model 204 can distinguish between classes. As shown, the accuracy and precision performance metrics increase and the recall performance metric decreases as the risk score 710 increases.

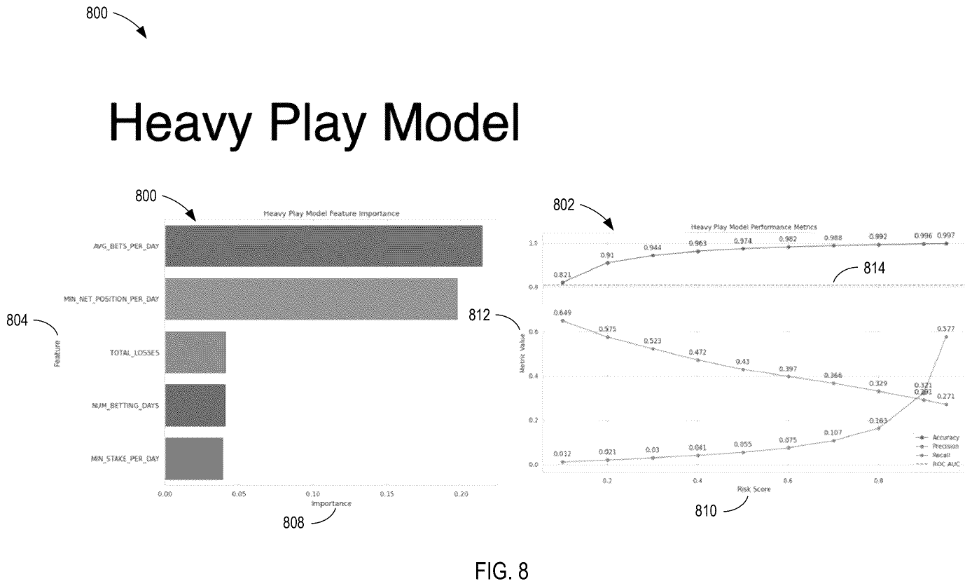

FIG. 8 depicts a bar chart 800 and a plot 802 representative of feature importance and performance metrics, respectively, for the third machine learning model 206 of FIG. 2. As shown, the bar chart 800 shows features 804 of betting data measured during a recent time period in which users interact with an electronic betting platform and their respective importance on determining the output of the third machine learning model 206.

The bar chart 800 includes a y-axis representative of each of the betting data features 804. The y-axis includes the betting data features 804 of an average number of bets per day (identified by “AVG_BETS_PER_DAY”), a minimum net position per day (e.g., the lowest amount a user has netted on a per day basis) (identified by “MIN_NET_POSITION_PER_DAY”), total losses (identified by “TOTAL_LOSSES”), a minimum betting stake per day (identified by “MIN_STAKE_PER_DAY”), and a maximum payout per day (identified by “MAX_PAYOUT_PER_DAY”).

The bar chart 800 includes an x-axis representative of a degree of importance 808 for each of the betting data features 804. The x-axis has a range of 0.000 to 0.200, but a different range may be used.

In the bar chart 800, the AVG_BETS_PER_DAY and the MIN_NET_POSITION_PER_DAY features 804 have the greatest importance for determining the output of the third machine learning model 206 of FIG. 2. For example, these features 804 of the betting data during a recent time period (e.g., the previous 30 days) in which a user interacts with the electronic betting platform 108 may have the most impact on the third machine learning model 206 determining the betting behavior value for the user.

Further, the bar chart 800 shows that these features 804 have more importance for the third machine learning model 206 than these same ones of the features 604 of FIG. 6 have for the first machine learning model 202. For example, the AVG_BETS_PER_DAY feature during the cumulative time period has more importance for predicting a likelihood of a user self-excluding from the electronic betting platform 108 than the AVG_BETS_PER_DAY feature during an initial time period.

Additionally, the bar chart 800 shows that the feature 804 AVG_BETS_PER_DAY has more importance for the third machine learning model 206 than for the second machine learning model 204. For example, the AVG_BETS_PER_DAY feature during the cumulative time period has more importance for predicting a likelihood of a user self-excluding from the electronic betting platform 108 than the AVG_BETS_PER_DAY feature during a recent time period.

The plot 802 represents the performance metrics for the second machine learning model 204. The plot 802 includes an x-axis of risk scores 810 in a range of 0.0 to 1.0. In some embodiments, the risk scores 810 may be the betting behavior scores 402 of FIG. 4 and/or one(s) of the risk scores 510, 512, 514, 516 of FIG. 5.

The plot 802 includes a y-axis of performance metric values 812 in a range of 0.0 to 1.0. The performance metric values 812 are shown for performance metrics of accuracy, precision, and recall for the third machine learning model 206. The plot 802 also shows a Receiver Operating Characteristic Area Under the Curve (ROC AUC) metric 814 that may measure how well the third machine learning model 206 can distinguish between classes. As shown, the accuracy and precision performance metrics increase and the recall performance metric decreases as the risk score 810 increases.

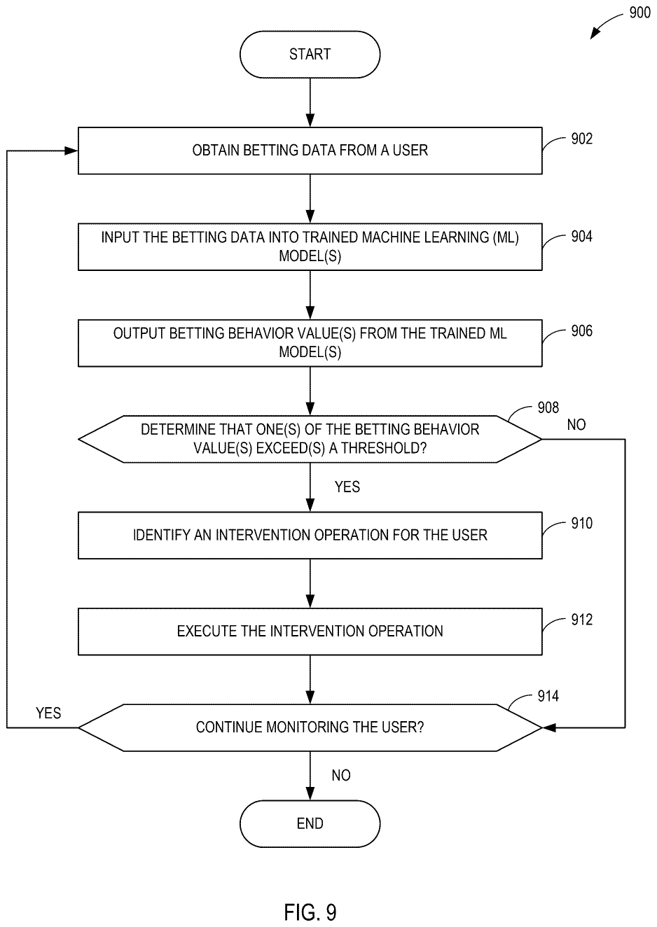

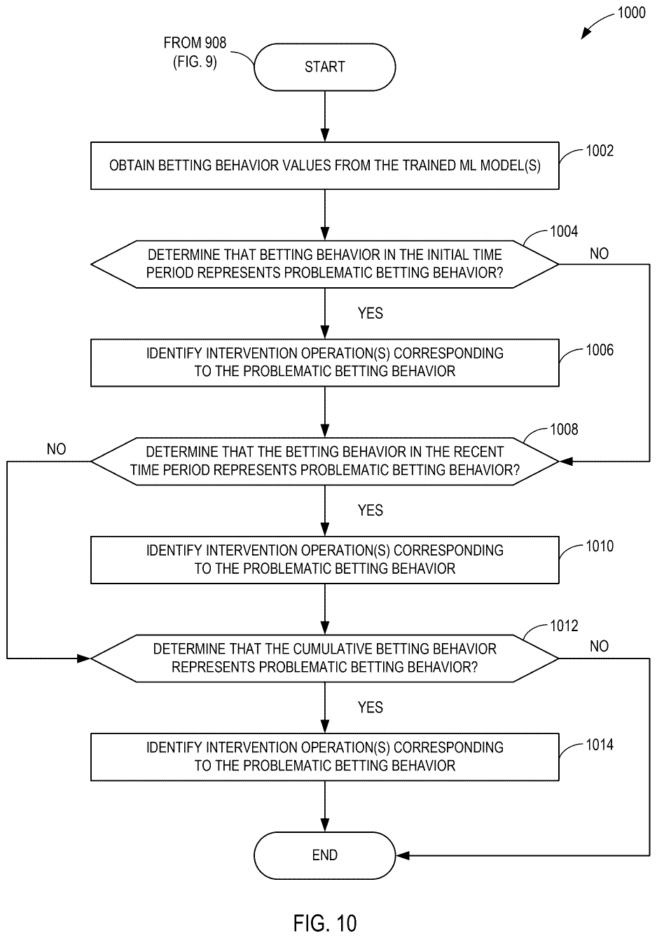

FIGS. 9-11 are flowcharts representative of example processes to be performed and/or example machine-readable instructions that may be executed by processor circuitry to implement the betting behavior monitoring software 102, the betting behavior classification service 126, and/or, more, generally, the betting behavior monitoring system 100 of FIG. 1. Additionally or alternatively, block(s) of one(s) of the flowcharts of FIGS. 9, 10, and/or 11 may be representative of state(s) of one or more hardware-implemented state machines, algorithm(s) that may be implemented by hardware alone such as an ASIC, etc., and/or any combination(s) thereof.

FIG. 9 is a flowchart 900 representative of an example process that may be performed and/or example machine-readable instructions that may be executed by processor circuitry to implement the betting behavior monitoring software 102 of FIGS. 1, 2, 3, and/or 4 to execute an intervention operation associated with problematic betting behavior of a user.

The flowchart 900 of FIG. 9 begins at block 902, at which the betting behavior monitoring software 102 may obtain betting data from a user. For example, the user device interface module 302 may obtain one or more sports bets 318 from the second user 106 of FIG. 1.

At block 904, the betting behavior monitoring software 102 may input the betting data into trained machine learning (ML) model(s). For example, the betting behavior classification service interface module 310 may output the betting data 322, based on the one or more sports bets 318, to the betting behavior classification service 126. In such an example, the betting behavior classification service 126 may input the betting data 322 into at least one of the first machine learning model 202, the second machine learning model 204, or the third machine learning model 206.

At block 906, the betting behavior monitoring software 102 may output betting behavior value(s) from the trained ML model(s). For example, the at least one of the first machine learning model 202, the second machine learning model 204, or the third machine learning model 206 may output a respective betting behavior value for the second user 106. The betting behavior classification service 126 may output the respective betting behavior value(s) for the second user 106 to the betting behavior classification service interface module 310. In some embodiments, the betting behavior classification service interface module 310 may output (e.g., through the RG dashboard interface module 314) the respective betting behavior value(s) to the electronic device 138 for presentation to the RG team member 136.

At block 908, the betting behavior monitoring software 102 may determine whether one(s) of the betting behavior value(s) exceed(s) a threshold. For example, the betting behavior analysis module 312 may determine whether at least one of the betting behavior value(s) for the second user 106 exceeds a betting behavior value threshold. In such an example, the betting behavior analysis module 312 may generate the betting behavior alert(s) 404 after determining that at least one of the betting behavior value(s) for the second user 106 exceeds a betting behavior value threshold. An example process that may be executed to implement block 908 is described below in connection with flowchart 1000 of FIG. 10.

In another example, the intervention module 316 may determine whether at least one of the betting behavior value(s) for the second user 106 exceeds a betting behavior value threshold. For example, the first machine learning model 202 may output a first betting behavior value of 0.85 for an initial time period in which the second user 106 interacted with the electronic betting platform 108. In such an example, the intervention module 316 may determine that the first betting behavior value of 0.85 exceeds a first threshold of 0.80 but does not exceed a second threshold of 0.9. In this example, exceeding the first threshold of 0.80 may correspond to one or more first intervention operations to be performed for the second user 106 while exceeding the second threshold of 0.90 may correspond to one or more second intervention operations to be performed for the second user 106.

At block 910, the betting behavior monitoring software 102 may identify an intervention operation for the user. For example, the RG team member 136 may identify at least one intervention operation, such as sending an e-mail, generating a pop-up notification, and/or disabling the user's access to betting portions of the electronic betting platform 108. In such an example, the at least one intervention operation may correspond to the first betting behavior value of 0.85 and/or the first betting behavior value of 0.85 exceeding the betting behavior threshold of 0.80.

At block 912, the betting behavior monitoring software 102 may execute the intervention operation. For example, the intervention module 316 may command the user device interface module 302 to carry out the at least one intervention operation 410. In such an example, the intervention module 316 may instruct the user device interface module 302 to send an e-mail, generate a pop-up notification, and/or disable the user's access to betting portions of the electronic betting platform 108.

At block 914, the betting behavior monitoring software 102 may determine whether to continue monitoring the user. For example, the user device interface module 302 may determine whether the second user 106 placed additional bet(s) through the electronic betting platform 108 such that the at least one machine learning model 128 may generate new betting behavior values for the second user 106.

If, at block 914, the betting behavior monitoring software 102 determines to continue monitoring the user, control returns to block 902. Otherwise, the example flowchart 900 of FIG. 9 concludes.

FIG. 10 is a flowchart 1000 representative of an example process that may be performed and/or example machine-readable instructions that may be executed by processor circuitry to implement the betting behavior monitoring software 102 of FIGS. 1, 2, 3, and/or 4 to identify an intervention operation associated with problematic betting behavior of a user. In some embodiments, the flowchart 1000 of FIG. 10 may be performed and/or executed to implement block 908 of the flowchart 900 of FIG. 9.

The flowchart 1000 of FIG. 10 begins at block 1002, at which the betting behavior monitoring software 102 may obtain betting behavior values from the trained ML model(s). For example, for the second user 106, the first machine learning model 202 may output a first betting behavior value, the second machine learning model 204 may output a second betting behavior value, and the third machine learning model 206 may output a third betting behavior value. In such an example, the betting behavior classification service interface module 310 may obtain the first through third betting behavior values from the betting behavior classification service 126.

At block 1004, the betting behavior monitoring software 102 may determine whether betting behavior in the initial time period represents problematic betting behavior. For example, the betting behavior score analysis module 312 may compare the first betting behavior value, which may correspond to the initial time period in which the second user 106 interacted with the electronic betting platform 108, to a betting behavior value threshold. In such an example, the betting behavior score analysis module 312 may determine that second user's 106 betting behavior in the initial time period is problematic betting behavior when the first betting behavior value meets and/or exceeds the betting behavior value threshold. The betting behavior value threshold may be a betting behavior value at or above which a user's betting behavior in the initial time period is indicative of problematic betting behavior.

If, at block 1004, the betting behavior monitoring software 102 determines that betting behavior in the initial time period does not represent problematic betting behavior, control proceeds to block 1008. If, at block 1004, the betting behavior monitoring software 102 determines that betting behavior in the initial time period represents problematic betting behavior, control proceeds to block 1006.

At block 1006, the betting behavior monitoring software 102 may identify intervention operation(s) corresponding to the problematic betting behavior. For example, the RG team member 136 (via the RG dashboard interface module 314) and/or the intervention module 316 may determine one or more intervention operations to support the second user 106 in responsibly gaming through the electronic betting platform 108. In such an example, the one or more intervention operations may correspond to a degree of problematic betting behavior exhibited by the second user 106 and represented by the first betting behavior value. After identifying the intervention operation at block 1006, control proceeds to block 1008.

At block 1008, the betting behavior monitoring software 102 may determine whether betting behavior in the recent time period represents problematic betting behavior. For example, the betting behavior score analysis module 312 may compare the second betting behavior value, which may correspond to the recent time period in which the second user 106 interacted with the electronic betting platform 108, to a betting behavior value threshold. In such an example, the betting behavior score analysis module 312 may determine that second user's 106 betting behavior in the recent time period is problematic betting behavior when the second betting behavior value meets and/or exceeds the betting behavior value threshold. The betting behavior value threshold may be a betting behavior value at or above which a user's betting behavior in the recent time period is indicative of problematic betting behavior. In some embodiments, the betting behavior value threshold for the initial time period is the same as the betting behavior value threshold for the recent time period while, in other embodiments, they are different from each other.

If, at block 1008, the betting behavior monitoring software 102 determines that betting behavior in the recent time period does not represent problematic betting behavior, control proceeds to block 1012. If, at block 1008, the betting behavior monitoring software 102 determines that betting behavior in the recent time period represents problematic betting behavior, control proceeds to block 1010.

At block 1010, the betting behavior monitoring software 102 may identify intervention operation(s) corresponding to the problematic betting behavior. For example, the RG team member 136 (via the RG dashboard interface module 314) and/or the intervention module 316 may determine one or more intervention operations to support the second user 106 in responsibly gaming through the electronic betting platform 108. In such an example, the one or more intervention operations may correspond to a degree of problematic betting behavior exhibited by the second user 106 and represented by the second betting behavior value. After identifying the intervention operation at block 1010, control proceeds to block 1012.

At block 1012, the betting behavior monitoring software 102 may determine whether the cumulative betting behavior represents problematic betting behavior. For example, the betting behavior score analysis module 312 may compare the third betting behavior value, which may correspond to the entire time period in which the second user 106 interacted with the electronic betting platform 108, to a betting behavior value threshold. In such an example, the betting behavior score analysis module 312 may determine that second user's 106 betting behavior in the recent time period is problematic betting behavior when the second betting behavior value meets and/or exceeds the betting behavior value threshold. The betting behavior value threshold may be a betting behavior value at or above which a user's betting behavior in the entire time period of user interaction is indicative of problematic betting behavior. In some embodiments, the betting behavior value threshold for the entire time period is the same as the betting behavior value threshold for the initial time period and/or the recent time period while, in other embodiments, they are different from one(s) of each other.

If, at block 1012, the betting behavior monitoring software 102 determines that the cumulative betting behavior does not represent problematic betting behavior, the example flowchart 1000 of FIG. 10 concludes. For example, the flowchart 1000 of FIG. 10 may return to block 910 of the flowchart 900 of FIG. 9 when at least one intervention operation for the user is identified. In another example, the flowchart 1000 of FIG. 10 may return to block 914 of the flowchart 900 of FIG. 9 when at least one intervention operation for the user is not identified.

If, at block 10112, the betting behavior monitoring software 102 determines that the cumulative betting behavior represents problematic betting behavior, control proceeds to block 1014. At block 1014, the betting behavior monitoring software 102 may identify intervention operation(s) corresponding to the problematic betting behavior. For example, the RG team member 136 (via the RG dashboard interface module 314) and/or the intervention module 316 may determine one or more intervention operations to support the second user 106 in responsibly gaming through the electronic betting platform 108. In such an example, the one or more intervention operations may correspond to a degree of problematic betting behavior exhibited by the second user 106 and represented by the third betting behavior value. After identifying the intervention operation at block 1014, the example flowchart 1000 of FIG. 10 concludes.

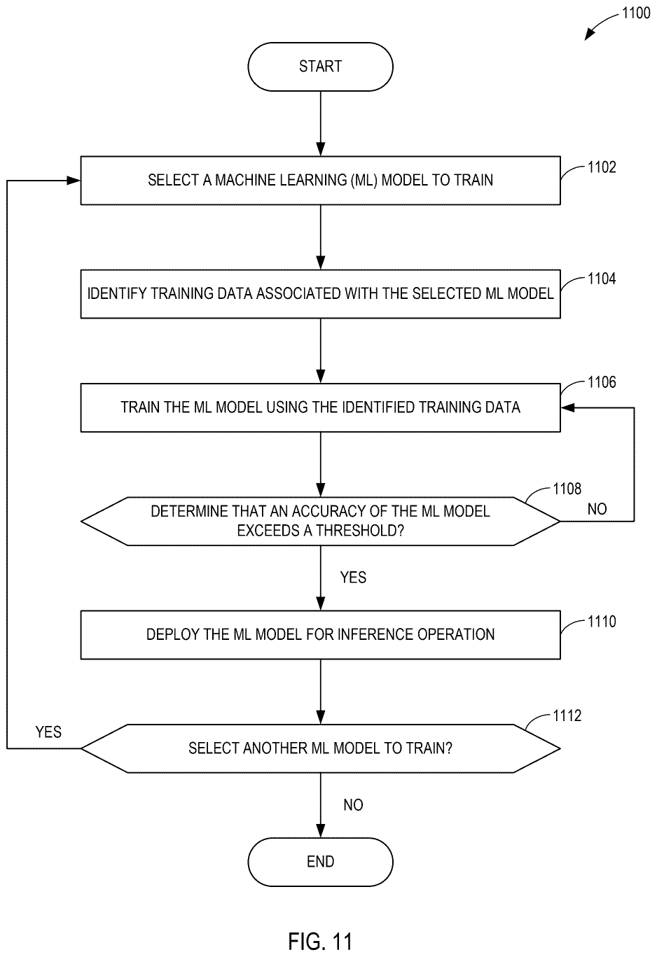

FIG. 11 is a flowchart 1100 representative of an example process that may be performed and/or example machine-readable instructions that may be executed by processor circuitry to implement the betting behavior monitoring software 102 of FIGS. 1, 2, 3, and/or 4 and/or the betting behavior classification service 126 of FIGS. 1 and/or 2 to train machine learning model(s) for predicting problematic betting behavior of user(s).

The flowchart 1100 of FIG. 11 begins at block 1102, at which the betting behavior monitoring software 102 may select a machine learning (ML) model to train. For example, the orchestration module 308 of FIG. 3 may determine to train (or retrain) at least one of the at least one trained machine learning model 128 of FIG. 1, such as at least the first machine learning model 202 of FIG. 2. Additionally and/or alternatively, the betting behavior classification service 126 may select at least one ML model to train.

At block 1104, the betting behavior monitoring software 102 may identify training data associated with the selected ML model. For example, the orchestration module 308 may identify betting data for the first users 212 and/or the second users 214 of FIG. 2 in an initial time period (e.g., a first 30 days of usage of the electronic betting platform 108) as training data for the first machine learning model 202. Additionally and/or alternatively, the betting behavior classification service 126 may identify the training data for training the first machine learning model 202.

At block 1106, the betting behavior monitoring software 102 may train the ML model using the identified training data. For example, the orchestration module 308 may query the datastore interface module 306 to retrieve the identified betting data from the betting history datastore 122 of FIGS. 1 and/or 2. The orchestration module 308 may output the retrieved betting data as the machine learning model training data 324 to the betting behavior classification service interface module 310. The betting behavior classification service interface module 310 may output the machine learning model training data 324 to the betting behavior classification service 126. The betting behavior classification service 126 may train, using the machine learning model training data 324, the first machine learning model 202.

At block 1108, the betting behavior monitoring software 102 may determine whether an accuracy of the ML model exceeds a threshold. For example, the betting behavior classification service 126 may train the first machine learning model 202 until a threshold for a performance metric, such as accuracy, for the first machine learning model 202 is met and/or exceeded. Additionally and/or alternatively, the betting behavior classification service 126 may train the first machine learning model 202 until (i) a precision of the first machine learning model 202 meets and/or exceeds a precision threshold and/or (ii) a recall of the first machine learning model 202 meets and/or exceeds a recall threshold.

If, at block 1108, the betting behavior monitoring software 102 determines that an accuracy of the ML model does not exceed a threshold, control returns to block 1106 to train (e.g., retrain) the ML model using the identified training data. Additionally and/or alternatively, the betting behavior classification service 126 may train the first machine learning model 202 using different training data and/or wait for new training data to be identified before retraining the first machine learning model 202.

If, at block 1108, the betting behavior monitoring software 102 determines that an accuracy of the ML model exceeds a threshold, control proceeds to block 1110. At block 1110, the betting behavior monitoring software 102 may deploy the ML model for inference operation. For example, after at least one of an accuracy, precision, or recall threshold is met and/or exceeded, the betting behavior classification service 126 may deploy the first machine learning model 202 for inference operation. In such an example, the first machine learning model 202 may ingest live betting data, such as bets from the first user 104 and/or the second user 106, to predict problematic betting behavior of users associated with the live betting data.

At block 1112, the betting behavior monitoring software 102 may determine whether to select another ML model to train. For example, the orchestration module 308 and/or the betting behavior classification service 126 may determine to train the second machine learning model 204 of FIG. 2.

If, at block 1112, the betting behavior monitoring software 102 determines to select another ML model to train, control returns to block 1102 to select another ML model to train. Otherwise, the example flowchart 1100 of FIG. 11 concludes.

Although the flowchart 1100 of FIG. 11 depicts sequential training of machine learning models, the embodiments disclosed herein are not so limited. For example, multiple machine learning models may be trained substantially simultaneously. In such an example, at least one of the first machine learning model 202, the second machine learning model 204, or the third machine learning model 206 may be trained substantially in parallel.

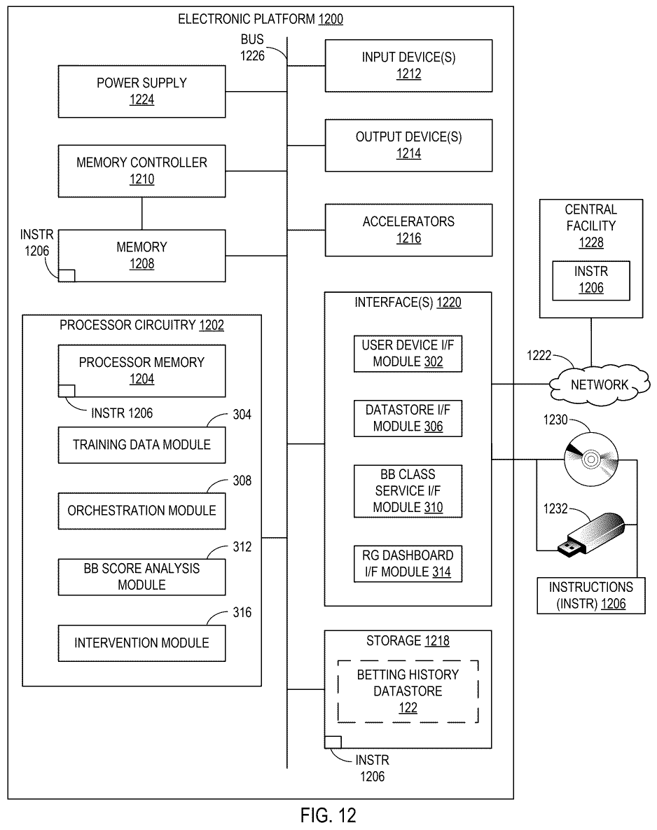

FIG. 12 is an example implementation of an electronic platform 1200 structured to execute the machine-readable instructions of FIGS. 9, 10, and/or 11 to implement the betting behavior monitoring software 102 of FIGS. 1, 2, 3, and/or 4. It should be appreciated that FIG. 12 is intended neither to be a description of necessary components for an electronic and/or computing device to operate as the betting behavior monitoring software 102, in accordance with the techniques described herein, nor a comprehensive depiction.

The electronic platform 1200 of this example may be an electronic device, such as a handset device (e.g., a cellular network device, a smartphone, etc.), a desktop computer, a laptop computer, a tablet computer, a server (e.g., a computer server, a blade server, a rack-mounted server, etc.), a wearable device (e.g., an augmented reality and/or virtual reality (AR/VR) device, a heads-up display (HUD) device, smart glasses, smart goggles, etc.), a workstation, or any other type of computing and/or electronic device.

The electronic platform 1200 of the illustrated example includes processor circuitry 1202, which may be implemented by one or more programmable processors, one or more hardware-implemented state machines, one or more ASICs, etc., and/or any combination(s) thereof. For example, the one or more programmable processors may include one or more CPUs, one or more DSPs, one or more FPGAs, one or more GPUs, etc., and/or any combination(s) thereof. The processor circuitry 1202 includes processor memory 1204, which may be volatile memory, such as random-access memory (RAM) of any type. The processor circuitry 1202 of this example implements the training data module 304, the orchestration module 308, the betting behavior analysis module 312, and the intervention module 316 of FIGS. 3-4.

The processor circuitry 1202 may execute machine-readable instructions 1206 (identified by INSTRUCTIONS), which are stored in the processor memory 1204, to implement at least one of the training data module 304, the orchestration module 308, the betting behavior analysis module 312, or the intervention module 316 of FIGS. 3-4. The machine-readable instructions 1206 may include data representative of computer-executable and/or machine-executable instructions implementing techniques that operate according to the techniques described herein. For example, the machine-readable instructions 1206 may include data (e.g., code, embedded software (e.g., firmware), software, etc.) representative of the flowcharts of FIGS. 9, 10, and/or 11, or portion(s) thereof.

The electronic platform 1200 includes memory 1208, which may include the instructions 1206. The memory 1208 of this example may be controlled by a memory controller 1210. For example, the memory controller 1210 may control reads, writes, and/or, more generally, access(es) to the memory 1208 by other component(s) of the electronic platform 1200. The memory 1208 of this example may be implemented by volatile memory, non-volatile memory, etc., and/or any combination(s) thereof. For example, the volatile memory may include static random-access memory (SRAM), dynamic random-access memory (DRAM), cache memory (e.g., Level 1 (L1) cache memory, Level 2 (L2) cache memory, Level 3 (L3) cache memory, etc.), etc., and/or any combination(s) thereof. In some examples, the non-volatile memory may include Flash memory, electrically erasable programmable read-only memory (EEPROM), magnetoresistive random-access memory (MRAM), ferroelectric random-access memory (FeRAM, F-RAM, or FRAM), etc., and/or any combination(s) thereof.

The electronic platform 1200 includes input device(s) 1212 to enable data and/or commands to be entered into the processor circuitry 1202. For example, the input device(s) 1212 may include an audio sensor, a camera (e.g., a still camera, a video camera, etc.), a keyboard, a microphone, a mouse, a touchscreen, a voice recognition system, etc., and/or any combination(s) thereof.

The electronic platform 1200 includes output device(s) 1214 to convey, display, and/or present information to a user (e.g., a human user, a machine user, etc.). For example, the output device(s) 1214 may include one or more display devices, speakers, etc. The one or more display devices may include an augmented reality (AR) and/or virtual reality (VR) display, a liquid crystal display (LCD), a light-emitting diode (LED) display, an organic light-emitting diode (OLED) display, a quantum dot (QLED) display, a thin-film transistor (TFT) LCD, a touchscreen, etc., and/or any combination(s) thereof. The output device(s) 1214 can be used, among other things, to generate, launch, and/or present a user interface. For example, the user interface may be generated and/or implemented by the output device(s) 1214 for visual presentation of output and speakers or other sound generating devices for audible presentation of output.

The electronic platform 1200 includes accelerators 1216, which are hardware devices to which the processor circuitry 1202 may offload compute tasks to accelerate their processing. For example, the accelerators 1216 may include artificial intelligence/machine-learning (AI/ML) processors, ASICs, FPGAs, graphics processing units (GPUs), neural network (NN) processors, systems-on-chip (SoCs), vision processing units (VPUs), etc., and/or any combination(s) thereof.

In some embodiments, one or more of the training data module 304, the orchestration module 308, the betting behavior analysis module 312, and/or the intervention module 316 may be implemented by one(s) of the accelerators 1216 instead of the processor circuitry 1202. In some examples, ones of the training data module 304, the orchestration module 308, the betting behavior analysis module 312, and the intervention module 316 may be executed concurrently (e.g., in parallel, substantially in parallel, etc.) by the processor circuitry 1202 and the accelerators 1216. For example, the processor circuitry 1202 and one(s) of the accelerators 1216 may execute in parallel function(s) corresponding to the betting behavior score analysis module 312.

The electronic platform 1200 includes storage 1218 to record and/or control access to data, such as the machine-readable instructions 1206. In this example, the storage 1218 optionally implements the betting history datastore 122 of FIGS. 1-2. The storage 1218 may be implemented by one or more mass storage disks or devices, such as HDDs, SSDs, etc., and/or any combination(s) thereof.

The electronic platform 1200 includes interface(s) 1220 to effectuate exchange of data with external devices (e.g., computing and/or electronic devices of any kind) via a network 1222. In this example, the interface(s) 1220 implement(s) the user device interface module 302 (identified by “USER DEVICE I/F MODULE”), the datastore interface module 306 (identified by “DATASTORE I/F MODULE”), the betting behavior classification service interface module 310 (identified by “BB CLASS SERVICE I/F MODULE”), and the dashboard interface module 314 (identified by “RG DASHBOARD I/F MODULE”) of FIGS. 3-4. The interface(s) 1220 of the illustrated example may be implemented by an interface device, such as network interface circuitry (e.g., a NIC, a smart NIC, etc.), a gateway, a router, a switch, etc., and/or any combination(s) thereof. The interface(s) 1220 may implement any type of communication interface, such as BLUETOOTH®, a cellular telephone system (e.g., a 4G LTE interface, a 5G interface, a future generation 6G interface, etc.), an Ethernet interface, a near-field communication (NFC) interface, an optical disc interface (e.g., a Blu-ray disc drive, a Compact Disk (CD) drive, a Digital Versatile Disk (DVD) drive, etc.), an optical fiber interface, a satellite interface (e.g., a BLOS satellite interface, a LOS satellite interface, etc.), a Universal Serial Bus (USB) interface (e.g., USB Type-A, USB Type-B, USB TYPE-C™ or USB-C™, etc.), etc., and/or any combination(s) thereof.

The electronic platform 1200 includes a power supply 1224 to store energy and provide power to components of the electronic platform 1200. The power supply 1224 may be implemented by a power converter, such as an alternating current-to-direct-current (AC/DC) power converter, a direct current-to-direct current (DC/DC) power converter, etc., and/or any combination(s) thereof. For example, the power supply 1224 may be powered by an external power source, such as an alternating current (AC) power source (e.g., an electrical grid), a direct current (DC) power source (e.g., a battery, a battery backup system, etc.), etc., and the power supply 1224 may convert the AC input or the DC input into a suitable voltage for use by the electronic platform 1200. In some examples, the power supply 1224 may be a limited duration power source, such as a battery (e.g., a rechargeable battery such as a lithium-ion battery).

Component(s) of the electronic platform 1200 may be in communication with one(s) of each other via a bus 1226. For example, the bus 1226 may be any type of computing and/or electrical bus, such as an I2C bus, a PCI bus, a PCIe bus, a SPI bus, and/or the like.

The network 1222 may be implemented by any wired and/or wireless network(s) such as one or more cellular networks (e.g., 4G LTE cellular networks, 5G cellular networks, future generation 6G cellular networks, etc.), one or more data buses, one or more local area networks (LANs), one or more optical fiber networks, one or more private networks, one or more public networks, one or more wireless local area networks (WLANs), etc., and/or any combination(s) thereof. For example, the network 1222 may be the Internet, but any other type of private and/or public network is contemplated.

The network 1222 of the illustrated example facilitates communication between the interface(s) 1220 and a central facility 1228. The central facility 1228 in this example may be an entity associated with one or more servers, such as one or more physical hardware servers and/or virtualizations of the one or more physical hardware servers. For example, the central facility 1228 may be implemented by a public cloud provider, a private cloud provider, etc., and/or any combination(s) thereof. In this example, the central facility 1228 may compile, generate, update, etc., the machine-readable instructions 1206 and store the machine-readable instructions 1206 for access (e.g., download) via the network 1222. For example, the electronic platform 1200 may transmit a request, via the interface(s) 1220, to the central facility 1228 for the machine-readable instructions 1206 and receive the machine-readable instructions 1206 from the central facility 1228 via the network 1222 in response to the request.

Additionally or alternatively, the interface(s) 1220 may receive the machine-readable instructions 1206 via non-transitory machine-readable storage media, such as an optical disc 1230 (e.g., a Blu-ray disc, a CD, a DVD, etc.) or any other type of removable non-transitory machine-readable storage media such as a USB drive 1232. For example, the optical disc 1230 and/or the USB drive 1232 may store the machine-readable instructions 1206 thereon and provide the machine-readable instructions 1206 to the electronic platform 1200 via the interface(s) 1220.

Techniques operating according to the principles described herein may be implemented in any suitable manner. The processing and decision blocks of the flowcharts above represent steps and acts that may be included in algorithms that carry out these various processes. Algorithms derived from these processes may be implemented as software integrated with and directing the operation of one or more single- or multi-purpose processors, may be implemented as functionally equivalent circuits such as a DSP circuit or an ASIC, or may be implemented in any other suitable manner. It should be appreciated that the flowcharts included herein do not depict the syntax or operation of any particular circuit or of any particular programming language or type of programming language. Rather, the flowcharts illustrate the functional information one skilled in the art may use to fabricate circuits or to implement computer software algorithms to perform the processing of a particular apparatus carrying out the types of techniques described herein. For example, the flowcharts, or portion(s) thereof, may be implemented by hardware alone (e.g., one or more analog or digital circuits, one or more hardware-implemented state machines, etc., and/or any combination(s) thereof) that is configured or structured to carry out the various processes of the flowcharts. In some examples, the flowcharts, or portion(s) thereof, may be implemented by machine-executable instructions (e.g., machine-readable instructions, computer-readable instructions, computer-executable instructions, etc.) that, when executed by one or more single- or multi-purpose processors, carry out the various processes of the flowcharts. It should also be appreciated that, unless otherwise indicated herein, the particular sequence of steps and/or acts described in each flowchart is merely illustrative of the algorithms that may be implemented and can be varied in implementations and embodiments of the principles described herein.

Accordingly, in some embodiments, the techniques described herein may be embodied in machine-executable instructions implemented as software, including as application software, system software, firmware, middleware, embedded code, or any other suitable type of computer code. Such machine-executable instructions may be generated, written, etc., using any of a number of suitable programming languages and/or programming or scripting tools, and also may be compiled as executable machine language code or intermediate code that is executed on a framework, virtual machine, or container.

When techniques described herein are embodied as machine-executable instructions, these machine-executable instructions may be implemented in any suitable manner, including as a number of functional facilities, each providing one or more operations to complete execution of algorithms operating according to these techniques. A “functional facility,” however instantiated, is a structural component of a computer system that, when integrated with and executed by one or more computers, causes the one or more computers to perform a specific operational role. A functional facility may be a portion of or an entire software element. For example, a functional facility may be implemented as a function of a process, or as a discrete process, or as any other suitable unit of processing. If techniques described herein are implemented as multiple functional facilities, each functional facility may be implemented in its own way; all need not be implemented the same way. Additionally, these functional facilities may be executed in parallel and/or serially, as appropriate, and may pass information between one another using a shared memory on the computer(s) on which they are executing, using a message passing protocol, or in any other suitable way.

Generally, functional facilities include routines, programs, objects, components, data structures, etc., that perform particular tasks or implement particular abstract data types. Typically, the functionality of the functional facilities may be combined or distributed as desired in the systems in which they operate. In some implementations, one or more functional facilities carrying out techniques herein may together form a complete software package. These functional facilities may, in alternative embodiments, be adapted to interact with other, unrelated functional facilities and/or processes, to implement a software program application.

Some exemplary functional facilities have been described herein for carrying out one or more tasks. It should be appreciated, though, that the functional facilities and division of tasks described is merely illustrative of the type of functional facilities that may implement using the exemplary techniques described herein, and that embodiments are not limited to being implemented in any specific number, division, or type of functional facilities. In some implementations, all functionalities may be implemented in a single functional facility. It should also be appreciated that, in some implementations, some of the functional facilities described herein may be implemented together with or separately from others (e.g., as a single unit or separate units), or some of these functional facilities may not be implemented.

Machine-executable instructions (e.g., processor-executable instructions) implementing the techniques described herein (when implemented as one or more functional facilities or in any other manner) may, in some embodiments, be encoded on one or more computer-readable media, machine-readable media, etc., to provide functionality to the media. Computer-readable media, machine-readable media, etc., include magnetic media such as a hard disk drive, optical media such as a CD or a DVD, a persistent or non-persistent solid-state memory (e.g., Flash memory, Magnetic RAM, etc.), or any other suitable storage media. Such a computer-readable medium, a machine-readable medium, etc., may be implemented in any suitable manner. As used herein, the terms “computer-readable media” (also called “computer-readable storage media”), “computer-readable medium” (also called “computer-readable storage medium”), “machine-readable media” (also called “machine-readable storage media”), and “machine-readable medium” (also called “machine-readable storage medium”) refer to tangible storage media. Tangible storage media are non-transitory and have at least one physical, structural component. In a “computer-readable medium” and “machine-readable medium” as used herein, at least one physical, structural component has at least one physical property that may be altered in some way during a process of creating the medium with embedded information, a process of recording information thereon, or any other process of encoding the medium with information. For example, a magnetization state of a portion of a physical structure of a computer-readable medium, a machine-readable medium, etc., may be altered during a recording process.

Further, some techniques described above comprise acts of storing information (e.g., data and/or instructions) in certain ways for use by these techniques. In some implementations of these techniques—such as implementations where the techniques are implemented as machine-executable instructions—the information may be encoded on a computer-readable storage media. Where specific structures are described herein as advantageous formats in which to store this information, these structures may be used to impart a physical organization of the information when encoded on the storage medium. These advantageous structures may then provide functionality to the storage medium by affecting operations of one or more processors interacting with the information; for example, by increasing the efficiency of computer operations performed by the processor(s).

In some, but not all, implementations in which the techniques may be embodied as machine-executable instructions, these instructions may be executed on one or more suitable computing device(s) and/or electronic device(s) operating in any suitable computer and/or electronic system, or one or more computing devices (or one or more processors of one or more computing devices) and/or one or more electronic devices (or one or more processors of one or more electronic devices) may be programmed to execute the machine-executable instructions. A computing device, electronic device, or processor (e.g., processor circuitry) may be programmed to execute instructions when the instructions are stored in a manner accessible to the computing device, electronic device, or processor, such as in a data store (e.g., an on-chip cache or instruction register, a computer-readable storage medium and/or a machine-readable storage medium accessible via a bus, a computer-readable storage medium and/or a machine-readable storage medium accessible via one or more networks and accessible by the device/processor, etc.). Functional facilities comprising these machine-executable instructions may be integrated with and direct the operation of a single multi-purpose programmable digital computing device, a coordinated system of two or more multi-purpose computing device sharing processing power and jointly carrying out the techniques described herein, a single computing device or coordinated system of computing device (co-located or geographically distributed) dedicated to executing the techniques described herein, one or more FPGAs for carrying out the techniques described herein, or any other suitable system.

Embodiments have been described where the techniques are implemented in circuitry and/or machine-executable instructions. It should be appreciated that some embodiments may be in the form of a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Various aspects of the embodiments described above may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

The phrase “and/or,” as used herein in the specification and in the claims, should be understood to mean “either or both,” of the elements so conjoined, e.g., elements that are conjunctively present in some cases and disjunctively present in other cases. Multiple elements listed with “and/or” should be construed in the same fashion, e.g., “one or more” of the elements so conjoined. Other elements may optionally be present other than the elements specifically identified by the “and/or” clause, whether related or unrelated to those elements specifically identified. Thus, as a non-limiting example, a reference to “A and/or B,” when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

The indefinite articles “a” and “an,” as used herein in the specification and in the claims, unless clearly indicated to the contrary, should be understood to mean “at least one.”

As used herein in the specification and in the claims, the phrase, “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently, “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

All definitions, as defined and used herein, should be understood to control over dictionary definitions, definitions in documents incorporated by reference, and/or ordinary meanings of the defined terms.

The word “exemplary” is used herein to mean serving as an example, instance, or illustration. Any embodiment, implementation, process, feature, etc., described herein as exemplary should therefore be understood to be an illustrative example and should not be understood to be a preferred or advantageous example unless otherwise indicated.

Having thus described several aspects of at least one embodiment, it is to be appreciated that various alterations, modifications, and improvements will readily occur to those skilled in the art. Such alterations, modifications, and improvements are intended to be part of this disclosure and are intended to be within the spirit and scope of the principles described herein. Accordingly, the foregoing description and drawings are by way of example only.

1. A method for predicting problematic betting behavior of users of an electronic betting platform, comprising:
receiving, using a network interface of betting behavior monitoring software, betting data associated with a user of the electronic betting platform, wherein the betting data is generated by processing one or more electronic bets placed by the user via the electronic betting platform into the betting data;
inputting the betting data into at least one trained machine learning model and outputting from the at least one trained machine learning model at least one respective betting behavior value, the at least one respective betting behavior value representative of a likelihood that the user is to self-exclude from the electronic betting platform for problematic betting behavior by the user, the at least one trained machine learning model comprising at least a first trained machine learning model, a second trained machine learning model, and a third trained machine learning model;
identifying, from the at least one respective betting behavior value, at least one intervention operation to provide electronic support resources to the user in connection with the identified problematic betting behavior; and
executing, using the network interface, the at least one intervention operation by at least in part transmitting the electronic support resources to the user via a computer-implemented network.

2. The method of claim 1, wherein:
the first trained machine learning model is trained to classify betting behavior of the user in a first time period,
the second trained machine learning model is trained to classify betting behavior of the user in a second time period, the second time period different from the first time period, and
the third trained machine learning model is trained to classify betting behavior of the user in a third time period, the third time period comprising at least a portion of the first time period and a portion of the second time period.

3. The method of claim 2, wherein the first time period is an initial time period that the user engaged with the electronic betting platform, the second time period is a recent time period that the user engaged with the electronic betting platform, and the third time period is a continuous time period that spans from the initial time period through the recent time period.

4. The method of claim 1, wherein at least one of the first trained machine learning model, the second trained machine learning model, or the third trained machine learning model comprises a neural network integrated with XGBoost.

5. The method of claim 1, wherein the at least one intervention operation comprises transmitting, to the user, an electronic message comprising the electronic support resources.

6. The method of claim 1, wherein the at least one intervention operation comprises implementing restrictions on betting behavior of the user.

7. The method of claim 1, wherein the at least one intervention operation comprises disabling access for the user to the electronic betting platform.

8. The method of claim 1, further comprising displaying, on at least one display device, the at least one respective betting behavior value to a member of a responsible gaming team.

9. At least one computer readable storage medium storing processor executable instructions that, when executed by at least one hardware processor, cause the at least one hardware processor to perform a method comprising:
receiving, using a network interface of betting behavior monitoring software, betting data associated with a user of an electronic betting platform, wherein the betting data is generated by processing one or more electronic bets placed by the user via the electronic betting platform into the betting data;
inputting the betting data into at least one trained machine learning model and outputting from the at least one trained machine learning model at least one respective betting behavior value, the at least one respective betting behavior value representative of a likelihood that the user is to self-exclude from the electronic betting platform for problematic betting behavior by the user, the at least one trained machine learning model comprising at least a first trained machine learning model, a second trained machine learning model, and a third trained machine learning model;
identifying, from the at least one respective betting behavior value, at least one intervention operation to provide electronic support resources to the user in connection with the identified problematic betting behavior; and
executing, using the network interface, the at least one intervention operation by at least in part transmitting the electronic support resources to the user via a computer-implemented network.

10. The at least one computer readable storage medium of claim 9, wherein:
the first trained machine learning model is trained to classify betting behavior of the user in a first time period,
the second trained machine learning model is trained to classify betting behavior of the user in a second time period, the second time period different from the first time period, and
the third trained machine learning model is trained to classify betting behavior of the user in a third time period, the third time period comprising at least a portion of the first time period and a portion of the second time period.

11. The at least one computer readable storage medium of claim 10, wherein the first time period is an initial time period that the user engaged with the electronic betting platform, the second time period is a recent time period that the user engaged with the electronic betting platform, and the third time period is a continuous time period that spans from the initial time period through the recent time period.

12. The at least one computer readable storage medium of claim 9, wherein at least one of the first trained machine learning model, the second trained machine learning model, or the third trained machine learning model comprises a neural network integrated with XGBoost.

13. The at least one computer readable storage medium of claim 9, wherein the at least one intervention operation comprises at least one of (i) transmitting, to the user, an electronic message comprising the electronic support resources, (ii) implementing restrictions on betting behavior of the user, or (iii) disabling access for the user to the electronic betting platform.

14. The at least one computer readable storage medium of claim 9, wherein the method further comprises displaying, on at least one display device, the at least one respective betting behavior value to a member of a responsible gaming team.

15. A system for predicting problematic betting behavior of users of an electronic betting platform comprising:
at least one hardware processor; and
at least one computer-readable storage medium storing processor executable instructions that, when executed by the at least one hardware processor, cause the at least one hardware processor to perform a method comprising:
receiving, using a network interface of betting behavior monitoring software, betting data associated with a user of the electronic betting platform, wherein the betting data is generated by processing one or more electronic bets placed by the user via the electronic betting platform into the betting data;
inputting the betting data into at least one trained machine learning model and outputting from the at least one trained machine learning model at least one respective betting behavior value, the at least one respective betting behavior value representative of a likelihood that the user is to self-exclude from the electronic betting platform for problematic betting behavior by the user, the at least one trained machine learning model comprising at least a first trained machine learning model, a second trained machine learning model, and a third trained machine learning model;
identifying, from the at least one respective betting behavior value, at least one intervention operation to provide electronic support resources to the user in connection with the identified problematic betting behavior; and
executing, using the network interface, the at least one intervention operation by at least in part transmitting the electronic support resources to the user via a computer-implemented network.

16. The system of claim 15, wherein:
the first trained machine learning model is trained to classify betting behavior of the user in a first time period,
the second trained machine learning model is trained to classify betting behavior of the user in a second time period, the second time period different from the first time period, and
the third trained machine learning model is trained to classify betting behavior of the user in a third time period, the third time period comprising at least a portion of the first time period and a portion of the second time period.

17. The system of claim 16, wherein the first time period is an initial time period that the user engaged with the electronic betting platform, the second time period is a recent time period that the user engaged with the electronic betting platform, and the third time period is a continuous time period that spans from the initial time period through the recent time period.

18. The system of claim 15, wherein at least one of the first trained machine learning model, the second trained machine learning model, or the third trained machine learning model comprises a neural network integrated with XGBoost.

19. The system of claim 15, wherein the at least one intervention operation comprises at least one of (i) transmitting, to the user, an electronic message comprising the electronic support resources, (ii) implementing restrictions on betting behavior of the user, or (iii) disabling access for the user to the electronic betting platform.

20. The system of claim 15, wherein the method further comprises displaying, on at least one display device, the at least one respective betting behavior value to a member of a responsible gaming team.
